(19) United States
(12) Patent Application Publication
(10) Pub. No.: US 2025/0093487 A1
(43) Pub. Date: Mar. 20, 2025

(54) WIRELSS COMMUNICATION SYSTEM WITH DISTRIBUTED SENSING CAPABILITY

(71) Applicant: KONINKLIJKE PHILIPS N.V., EINDHOVEN (NL)

(72) Inventors: Nicholas Simon Walker, Lausanne (CH); Timothy Beard, Cambridge (GB); Oscar Garcia Morchon, Eindhoven (NL); Walter Dees, Eindhoven (NL); Harry Michael Cronin, Lausanne (CH)

(21) Appl. No.: 18/720,642

(22) PCT Filed: Dec. 15, 2022
(86) PCT No.: PCT/EP2022/086118

§ 371 Date: Jun. 16, 2024

(30) Foreign Application Priority Data
Dec. 17, 2021 (EP) 21215345.6
Apr. 29, 2022 (EP) 22171045.2
Aug. 7, 2022 (EP) 22189163.3

(51) Int. Cl. G01S 13/46; G01S 13/00

(52) U.S. Cl. CPC G01S 13/46; G01S 13/003

(57) ABSTRACT

Systems and methods for providing sensing capability in a wireless communication system, wherein a part of the communication spectrum is configured for a period of time to enable performing sensing by establishing a distributed sensing system between a base station (100) or terminal device, as transmitter device, and a terminal device (120) or base station, as receiver device, in such a way that the lack of analogue signal exchange and the additional path length caused by the transmitter-receiver distance (and, in embodiments, the receiver-target distance) are corrected for, while parameters that need to be communicated are configured for the application required.

### FIELD OF THE INVENTION

The invention relates to the field of communication between terminal devices and/or fixed or mobile access devices in wireless networks, such as—but not limited to—fifth generation (5G) cellular communication systems.

### BACKGROUND OF THE INVENTION

As the wavelength of communication systems decreases, the ability to use the same wavebands for increasingly precise sensing applications improves.

So-called ‘mmWave’ radar is a contactless sensing technology for detecting objects and providing range, velocity and angle of these objects and operates in a spectrum between 30 GHz and 300 GHz. Due to the technology's use of small wavelengths, it can provide sub-mm range accuracy and is able to penetrate certain materials such as plastic, drywall, clothing, and is relatively impervious to environmental conditions such as rain, fog, dust and snow. The ability to sense surface positions and movements at sub-mm scale enables such systems to perform vital signs monitoring.

As an example, signal wavebands of 5G communication systems or other suitable wireless communication systems can be used as mmWave radar e.g. to measure locations and movements of cars and people and even vital sign signals such as heart rate and breathing rate, but this requires knowledge of the transmission environment, approximate target location, and suitable modifications to the signaling system.

However, radar systems or other sensing systems are usually implemented as single non-distributed systems comprising a transmitter and a receiver to enable communication of analogue signals and timing. Therefore, a duplication of equivalent system elements and other substantial modifications of communication system hardware are required to achieve adequate sensing capability.

### SUMMARY OF THE INVENTION

It is an object of the present invention to provide sensing capability for communication systems while minimizing modification requirements.

This object is achieved by an apparatus as claimed in claim 1, by a wireless communication device as claimed in claim 17, by a system as claimed in claim 18, by a method as claimed in claim 26, and by a computer program product as claimed in claim 27.

According to a first aspect related to a wireless communication device (e.g., access device or terminal device) at a receiver side of a distributed sensing function, an apparatus is provided for providing radar sensing capability in the wireless communication device, the apparatus comprising:
a wireless communication unit for receiving a communication signal from a remote wireless communication device at another communication end;
a reception frontend for receiving radio frequency signals;
a detection unit for detecting a sensing signal at the output of the reception frontend based on sensing parameter information included in the received communication signal;
an analysis system configured to perform based on the received sensing signal and the sensing parameter information included in the received communication signal at least one of:
   determining a timing, phase shift, frequency, amplitude or signal deformation of the sensing signal to further determine if the sensing signal is reflected by a target object or is sent via a direct non-reflected path; or
   generating a filtered signal to transmit to a further processing unit to extract sensing information about a target object; or
   determining a position, a movement or a structure of a target object.

According to a second aspect related to the wireless communication device (e.g., access device or terminal device) at the receiver side of the distributed sensing function, a method is provided for providing sensing capability in a wireless communication device, the method comprising:
receiving a communication signal from a remote device at another communication end; detecting a sensing signal at the output of a radio frequency reception frontend based on sensing parameter information included in the received communication signal;
performing based on the received sensing signal and the sensing parameter information included in the received communication signal at least one of:
   determining a timing, phase shift, frequency, amplitude or signal deformation of the sensing signal to further determine if the sensing signal is reflected by a target object or is sent via a direct non-reflected path; or
   generating a filtered signal to transmit to a further processing unit to extract sensing information about a target object; or
   determining a position, a movement or a structure of a target object.

According to a third aspect, a wireless communication device comprising an apparatus of the first aspect is provided.

According to a fourth aspect, a system is provided, which comprises at least one wireless communication device according to the third aspect and at least one remote wireless communication device for transmitting the received sensing signal.

Finally, according to a fifth aspect, a computer program product is provided, which comprises code means for producing the steps of the method of the second aspect when run on a processor of a wireless communication device. Accordingly, the invention enables a flexible method for terminal devices (e.g., UEs, sensors, etc.) or access devices (e.g., base stations, access points, etc.) to request a period of sensing directed at a suggested target object for a suggested time period, using only moderate modifications of the components of the communication system. This allows handset-directed sensing by a sensing function (e.g., a radar sensing function, a CSI-based sensing function, etc.) integrated with standard or conventional communication systems, in which spatial receiver-to-target and receiver-to-transmitter separations are accounted for and without an analogue emitted signal required at the receiver handset.

Thereby, vital signs (e.g., heart rate, breathing rate, etc.) of a selected individual or multiple individuals (e.g., human beings or animals) or position and movements of a target object or multiple target objects can be measured. This may include specific movements such as detecting a person falling. Moreover, if vital signs are measured from a target object, this information can be used for discriminating an individual person from an object.

Furthermore, the proposed integrated sensing function can be used for measuring skin permittivity (at a defined radio frequency) of a surface, which can be used as a measure of e.g. stress (e.g. over time).

According to a first option which may be combined with any of the above first to fifth aspects, wherein the received signal may be a radar signal, or a chirp signal, or a training symbol of a channel state information. Thereby, various sensing options for implementing the distributed sensing system can be provided.

According to a second option which may be combined with the first option or any of the above first to fifth aspects, the wireless communication unit of the wireless communication device may be used to transmit a sensing measurement request to the remote wireless communication device in order to receive at least one of the sensing parameter information or resource allocation information for sensing. Thereby, a distributed radar sensing operation or a semi-persistent scheduling in a sensing mode can be initiated at the remote wireless communication device (transmitter of the distributed sensing system) via a standard communication link. This can be done in a secure manner by using e.g. RRC signaling. According to a third option which may be combined with the first or second option or any of the above first to fifth aspects, the wireless communication unit of the wireless communication device may be used to transmit at least one of a required scan time for sensing measurement and a rough indication of a direction and range to the target object to the remote wireless communication device. Thereby, the wireless communication unit at the remote wireless communication device (transmitter of the distributed radar system) can initiate a preparatory set-up of its distributed sensing function and antenna beamforming according to the received information.

According to a fourth option which can be combined with any of the first to third options or any of the above first to fifth aspects, the sensing parameter information may comprise one or more information type selected from the set comprising: timing, phase and frequency information, an identification of an algorithm or filter to be used for processing, an application identifier, or a sensing signal identifier of the received sensing signal. This preparatory information allows the communication unit of the wireless communication device (receiver of the distributed sensing system) to generate by means of its communication unit a proper synthetic sensing signal that matches with the real sensing signal generated at the remote wireless communication device (transmitter of the distributed sensing system).

According to a fifth option which can be combined with any of the first to fourth options or any of the above first to fifth aspects, a signal generator may be provided for generating based on the sensing parameter information included in the received communication signal an internal synthetic sensing signal, wherein the analysis system is configured to combine the synthetic sensing signal with the received sensing signal. Thereby, a joint transmitter and receiver sensing system (“non-distributed” sensing system) can be provided for measuring desired parameters of the received sensing signal, or a system can be provided whereby the transmitter and receiver are physically distributed, but which together operate equivalently to a non-distributed sensing system and/or a system in which the receiver reuses components/subsystems of a non-distributed sensing system.

According to a sixth option which can be combined with any of the first to fifth options or any of the above first to fifth aspects, the signal generator may be configured to use a discrete Fourier transform spread orthogonal frequency division multiplexing signal generation process of the wireless communication unit to generate a chirp signal as the internal synthetic sensing signal matching the received sensing parameter information. This measure provides the advantage that an available signal generation process of the communication unit at the receiver of the distributed sensing system can be adapted to generate a synthetic sensing signal for a non-distributed sensing receiver function without requiring substantial modifications.

According to a seventh option which can be combined with any of the first to sixth options or any of the above first to fifth aspects, the analysis system may be configured to generate an intermediate frequency signal by combining the internal synthetic sensing signal with the received sensing signal, to perform filtering and analogue-to-digital conversion of the intermediate frequency signal to obtain a digital intermediate frequency signal, and to process the digital intermediate frequency signal to yield application-specific position, movement or structure data or to transmit the digital intermediate frequency signal to the remote wireless communication device or a network function/device or a cloud to perform further application-specific processing. Thus, available components of the communication unit of the wireless communication device at the receiver side of the distributed sensing system can be used to implement a non-distributed analysis system without requiring substantial modifications.

According to an eighth option which can be combined with any of the first to seventh options or any of the above first to fifth aspects, a time delay measurement functionality may be provided by using the wireless communication unit to perform a two-way time delay measurement in cooperation with the remote wireless communication device. Thereby, delay compensation of a distributed sensing system can be achieved without substantial modifications of the communication devices.

According to a ninth option which can be combined with any of the first to eighth options or any of the above first to fifth aspects, at least one movement sensor for measuring movements and/or vibrations of the wireless communication device may be provided. Thus, movements and/or vibrations at the receiver side of the distributed sensing system can be compensated for.

According to a tenth option which can be combined with any of the first to ninth options or any of the above first to fifth aspects, a lower-resolution non-distributed analysis system may be provided at the receiver side of the distributed radar system to provide a non-distributed location scanning capability. This additional non-distributed analysis system can be used to perform a preparatory scanning operation for obtaining a rough location of the target object.

According to an eleventh option which can be combined with any of the first to tenth options or any of the above first to fifth aspects, the analysis system may be configured to detect a location and/or movement of the target object based on an isolated surface derived from a constant line detected in the digital intermediate frequency signal, or to detect a heart rate and breathing rate based on isolated and unwrapped phase data of a selected surface derived from a constant line detected in the digital intermediate frequency signal, or to measure a skin conductivity based on an estimation of a total reflectivity of a selected surface derived from a constant line detected in the digital intermediate frequency signal. Thus, various sensing or measuring applications can be added to wireless communication devices without requiring substantial modifications.

According to a twelfth option which can be combined with any of the first to eleventh options or any of the above first to fifth aspects, the analysis system may be configured to detect a unique spatial location of a surface of the target object by finding intersections of equal-distance return ellipses or circles of receiver devices of the sensing signal and constraining the position by a direction angle and beam spread angle of a transmitter beam of the remote wireless communication device. Thereby, a unique location of the target object can be obtained by using distributed receivers of the distributed sensing system.

According to a thirteenth option which can be combined with any of the first to twelfth options or any of the above first to fifth aspects, the remote wireless communication device (transmitter of the distributed radar system) may be configured to determine if it can respond to a sensing measurement request received from the wireless communication device and respond with a sensing session confirmation or a sensing session denial message based on the determination result. Thereby, a temporary on-demand sensing function can be established in a wireless communication system.

According to fourteenth option which can be combined with any of the first to thirteenth options or any of the above first to fifth aspects, the remote wireless communication device (transmitter of the distributed radar system) may be configured to determine the sensing parameter information including parameters of at least one of a signal to be used as the sensing signal, a rough position of the target object or a position offset from the remote wireless communication device to the wireless communication device and to communicate the sensing parameter information along with a future time for a first sensing signal or a future schedule for the sensing signal to the wireless communication device. Thereby, the wireless communication unit at the receiver side of the distributed sensing system can be adapted to the sensing signal and target object for achieving a matched sensing receiver function. Use of the future schedule allows that the remote device assigns a semi-persistent schedule. This is useful, e.g., for vital sign monitoring.

According to a fifteenth option which can be combined with any of the first to fourteenth options or any of the above first to fifth aspects, the remote wireless communication device (transmitter of the distributed sensing system) may be configured to transmit the sensing signal at the communicated future time by using a discrete Fourier transform spread orthogonal frequency division multiplexing signal generation process of a wireless communication unit to generate the sensing signal by converting a single-carrier nature of the discrete Fourier transform spread orthogonal frequency division multiplexing signal to a linear combination of chirp signals circularly translated in the time domain. Thus, an available signal generation process of the communication unit can be used for generating the sensing signal used in the distributed sensing system.

According to a sixteenth option which can be combined with any of the first to fifteenth options or any of the above first to fifth aspects, the remote wireless communication device (transmitter of the distributed sensing system) may be configured to determine a target angle and a distance to the target object by using a location estimation sensing operation of a non-distributed sensing system provided at the remote wireless communication device. Thereby, an estimation of the angle and distance of the target object can be obtained at the transmitter side of the distributed sensing system and communicated to the receiver side for preparatory beamforming.

According to a seventeenth option which can be combined with any of the first to sixteenth options or any of the above first to fifth aspects, the remote wireless communication device (transmitter of the distributed sensing system) may be configured to use a wireless communication unit to perform a two-way time delay measurement in cooperation with the wireless communication device (receiver of the distributed sensing system). Thereby, a delay compensation of the sensing result can be achieved without substantive modifications by using the available wireless communication units.

According to an eighteenth option which can be combined with any of the first to seventeenth options or any of the above first to fifth aspects, a clock-level synchronization between the remote wireless communication device (transmitter of the distributed sensing system) and the wireless communication device (receiver of the distributed sensing system) may be achieved by a time synchronization and delay compensation measurement process using wireless communication signals. Thereby, a proper timing of the generated internal synthetic sensing signal can be ensured.

According to a nineteenth option which can be combined with any of the first to eighteenth options or any of the above first to fifth aspects, the wireless communication device (receiver of the distributed sensing system) may be configured to transmit to the remote wireless communication device (transmitter of the distributed sensing system) a resource scheduling message requesting scheduling of sensing session resources, and the remote wireless communication device may reply to the wireless communication device with a downlink control information message including the allocated resources, e.g., a secure RRC message. Thereby, the temporary on-demand sensing function can be scheduled without substantial modifications by using an available resource scheduling process of the wireless communication devices.

According to a twentieth option which can be combined with any of the first to nineteenth options or any of the above first to fifth aspects, the analysis system is configured to detect that the sensing information about a target object or the determined position, a movement or a structure of a target object does not correspond to the given information on how to identify the target, and based thereon the apparatus discards the received sensing signal or sensing information, and/or may not perform any further processing on the measurements, results and/or input/output data, and/or may not transmit to a further processing unit.

According to a twenty first option which can be combined with any of the first to twentieth options or any of the above first to fifth aspects, the analysis system is configured to detect a biometric based on the sensing information about a target object and/or the determined position, a movement or a structure of a target object, and whereby depending on whether the respective biometric is detected or not detected, the sensing session may be continued or aborted, or the sensing information may be approved for further processing/storage or discarded, or a different target object or different wireless communication device or different remote wireless communication device may be selected.

According to a sixth aspect of the invention, it is proposed an apparatus for an emergency call, the apparatus comprising
a communication unit including a transmitter and a receiver and
a controller controlling the communication unit,
the controller being configured for performing a sensing session upon reception from a network node of a request for sensing a designated target.

According to a seventh aspect of the invention, it is proposed a network node in a communication network, comprising
a communication unit including a transmitter and a receiver,
a controller controlling the communication unit,
wherein the controller is configured, upon reception of an emergency call from a first wireless device, to request one or more wireless sensing devices located in the vicinity of the first wireless device to perform a sensing session of a designated target victim.

According to an eighth aspect of the invention, it is proposed a method for operating an apparatus, the method comprising
receiving a sensing request for a designated target victim in the vicinity of the apparatus, and
performing a sensing session based on the request.

According to a ninth aspect of the invention, it is proposed a method for operating a network node, the method comprising
receiving an emergency call from a first wireless device,
requesting one or more sensing wireless devices located in the vicinity of the first wireless device to perform a sensing session of a designated target victim.

In a first option of the sixth or seventh aspects of the invention, the request may include one or more configuration parameters including:
authorization information, or
information about the target, such as target location or target area or target volume, or
situation about the target, such as mobility, position, vital signs
context information, such as the presence of other persons around the victim, distance between people, and their devices relative to the victim, number of injured people, debris in vicinity, or
an identifier or address (e.g. IP address, URL) of a destination server, or
network function/device or public safety answering point or
a credential (e.g. public key) to be used for encrypting the results, or
requested sensing results such as target position or movement or vital signs.

In a second option which can be implemented with the first option or with the sixth or seventh aspects of the invention, the network node includes or is connected to a public safety answering point via a network.

In a third option which can be combined with the first or second options or with the sixth or seventh aspects of the invention, the controller is configured to initiate an emergency call causing the network node to request the sensing session.

In a fourth option which can be combined with any of the first to third options or the sixth or seventh aspects of the invention, the controller is configured to include location information in the emergency call.

In a fifth option which can be combined with the third or fourth options, the controller is configured to include available sensing results in the emergency call.

In a sixth option which can be combined with any of the third to fifth options, the controller is configured to include the apparatus sensing capabilities and/or an indication that sensing results are available or can be acquired.

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the wireless communication device of claim 17, the system of claim 18, the method of claim 26, the computer program product of claim 27, the apparatus of claim 28, the network node of claim 35, the method of claim 36 or 37 or the computer program of claim 38 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows a communication system with distributed radar function according to an embodiment;

FIG. 2 schematically shows a transmitter and receiver architecture according to various embodiments;

FIG. 3 schematically shows a process flow diagram for radar sensing in a communication system according to an embodiment;

FIG. 4 schematically shows a flow diagram of a radar sensing operation according to an embodiment;

FIG. 5 schematically shows a flow diagram of a location and movement detection process according to an embodiment;

FIG. 6 schematically shows a flow diagram of a heart rate and breathing rate detection process according to an embodiment;

FIG. 7 schematically shows a flow diagram of a skin conductivity measurement process according to an embodiment;

FIG. 8 schematically shows a signaling and processing diagram of a radar sensing process in a multi-receiver system according to an embodiment;

FIG. 9 schematically shows an example of an improved position location estimation with one transmitter device and two receiver devices according to an embodiment; and

FIG. 10 schematically shows an example of an improved position location estimation with one receiver device and one transmitter device that also operates as a receiver revice, according to an embodiment.

FIG. 11 schematically shows a communication system with distributed sensing system according to another embodiment.

### DETAILED DESCRIPTION OF EMBODIMENTS

Embodiments of the present invention are now described based on a cellular communication network environment, such as 5G. However, the present invention may also be used in connection with other wireless technologies (e.g., IEEE 802.11/Wi-Fi or IEEE 802.15.4/ultra-wide-band communication (UWB)) in which wireless sensing is provided or can be introduced.

Throughout the present disclosure, the abbreviation “gNB” (5G terminology) or “BS” (base station) is intended to mean a wireless access device such as a cellular base station or a WiFi access point or a UWB PAN coordinator. The gNB may consist of a centralized control plane unit (gNB-CU-CP), multiple centralized user plane units (gNB-CU-UPs) and/or multiple distributed units (gNB-DUs). The gNB is part of a radio access network (RAN), which provides an interface to functions in the core network (CN). The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

Furthermore, the terms “base station” (BS) and “network” may be used as synonyms in this disclosure. This means for example that when it is written that the “network” performs a certain operation it may be performed by a CN function of a wireless communication network, or by one or more base station that are part of such wireless communication network, and vice versa. It can also mean that part of the functionality is performed by a CN function of the wireless communication network and part of the functionality by the base station.

Moreover, the terms “radar sensing” and “wireless sensing” are intended to cover not only techniques whereby a single device both sends and receives a radar signal, but also distributed RF based sensing techniques, such as techniques whereby the sensing signal is received by multiple devices in a distributed manner or techniques that are based on sensing of a channel state information (CSI) in a CSI-based distributed sensing solution and/or based on other types measurement information related to RF signals (e.g. MIMO sounding signal feedback, doppler phase shift measurements). The terms “radar sensing” and “wireless sensing” are used interchangeably in the description, and embodiments describing radar sensing as an example also extend to any kind of wireless sensing, such as e.g. CSI based sensing.

Furthermore, the terms “target” and “target object” indicate any entity that may be subject to wireless sensing. This may include people, animals, inanimate objects, structures consisting of several smaller entities (e.g. a cloud consisting of small waterdrops)). Also, the terms “target” and “target object” may be used as synonyms in this disclosure.

It is noted that throughout the present disclosure only those blocks, components and/or devices that are relevant for the proposed data distribution function are shown in the accompanying drawings. Other blocks have been omitted for reasons of brevity. Furthermore, blocks designated by same reference numbers are intended to have the same or at least a similar function, so that their function is not described again later.

### Sensing Signals

The sensing function of the following embodiments may be implemented, e.g. by implementation of a radar functionality in wireless communication involving one or more access devices (e.g., base stations (BS)) and/or one or more terminal devices (e.g., UEs).

As an example, Frequency Modulated Continuous Wave (FMCW) mmWave radar systems can measure range, velocity, and angle of arrival (if two receivers are available) of objects in the scene which reflect radio waves. Such radar systems emit a chirp signal, e.g., a sine wave that increases in frequency over time. The chirp signal (e.g., a continuous wave pulse) has a bandwidth and a frequency increase rate. Generally, a continuous series of such chirps are emitted. The transmitted and received analogue chirp signals are mixed to generate an intermediate frequency (IF) signal which corresponds to the difference in frequencies of the two signals (outbound and inbound) and whose output phase corresponds to the difference in the phases of the two signals.

Each surface of a scene or environment will therefore produce a constant frequency IF signal whose frequency relates to the distance to the surface (i.e., a first distance from the transmitter of the chirp signal to the surface plus a second distance from the surface to the receiver of the chirp signal). To resolve two surfaces at different distances, the two IF signals can be frequency resolved. A longer time window of the IF signal results in greater resolution. As the chirp time is related to its bandwidth (with constant chirp frequency change) the resolution of the radar is related to the chirp bandwidth. The IF signal may then be band pass filtered (to remove signals below some minimal range and frequencies above the maximum frequency for a subsequent analogue-to-digital converter (ADC)) and digitized prior to further processing. The upper frequency sensing range of the bandpass filter and ADC sets the maximum range that can be detected (i.e., IF frequencies increase with range).

To detect vibrations, the phase of the IF signal is important, since the phase (i.e., the difference in phases of the transmitted and received chirp signals) is a sensitive measure of small changes in the distance of a surface. Small distance changes can be detected in the phase signal but may be indiscernible in the frequency signal. Moreover, phase difference measures between two consecutive chirp signals can be used to determine the velocity of the surface.

As an example, a fast Fourier transform (FFT) processing can be performed across multiple chirp signals to enable separation of objects with the same range but moving at different velocities. A Fourier transform converts a signal from a space or time domain into the frequency domain. In the frequency domain the signal is represented by a weighted sum of sine and cosine waves. A discrete digital signal with N samples can be represented exactly by a sum of N waves. FFT provides a faster way of computing a discrete Fourier transform by using the symmetry and repetition of waves to combine samples and reuse partial results. This method can save a huge amount of processing time, especially with real-world signals that can have many thousands or even millions of samples.

As a further example, angle estimation can be performed by using the phase difference between the received chirp signal at two separated receivers.

As another option, a channel state information (CSI) can be used, which is a measure of the phases and amplitudes of many frequencies detected at a receiver, thereby forming a complex ‘map’ of the radio environment, including effects of objects within that environment. CSI characterizes how wireless signals propagate from the transmitter to the receiver at certain carrier frequencies. CSI amplitude and phase are impacted by multi-path effects including amplitude attenuation and phase shift, e.g., by the displacements and movements of the transmitter, receiver, and surrounding objects and humans. In other words, CSI captures the wireless characteristics of the nearby environment. These characteristics, assisted by mathematical modeling or machine learning algorithms, can be used for different sensing applications.

A radio channel may be divided into multiple subcarriers—as is done e.g. in 5G communication systems (using e.g. orthogonal frequency division multiplexing (OFDM)). To measure CSI, the transmitter may send long training symbols (LTFs), which contain pre-defined symbols for each subcarrier, e.g., in a packet preamble. When those LTFs are received, the receiver can estimate a CSI matrix using the received signals and the original LTFs. For each subcarrier, the channel can be modeled by y=Hx+n, where y is the received signal, x is the transmitted signal, H is the CSI matrix, and n is the noise vector. The receiver estimates the CSI matrix H using a pre-defined signal x and the received signal y after signal processing such as removing cyclic prefix, de-mapping and demodulation. The estimated CSI is then a three-dimensional matrix of complex values and this matrix represents an ‘image’ of the radio environment at that time. By processing a time series of such ‘images’ information on movements, locations and vibrations of objects can be extracted.

Such a processing of a CSI matrix can be used for vital signs monitoring, presence detection, and human movement recognition. As an example, neural network like recognition techniques can be used to process the CSI matrix to perform such kinds of recognition.

It is noted that systems using channel state information (CSI) are somehow related to systems with FMCW mmWave radar. In a CSI-based system, the input signal x may be defined and the receiver may use the received signal y to obtain H, i.e., as H=(Y−N)/X. In a FMCW mmWave radar, the transmitted signal Chirp x may also be predefined, and the receiver may uses the received signal y to obtain a transfer function as H=Y/X. This last step is in fact somehow related to multiplying the locally computed chirp signal and the received chirp signal and applying a bandpass filter. According to various embodiments described below, the above described wireless sensing techniques are implemented in a mobile communication system (e.g. 5G or other cellular or WiFi communication systems), while the functional coexistence of radar and communication operating in the same frequency bands is configured to avoid interference bandwidths. Thereby, radio sensing can be integrated into large-scale mobile networks to create perceptive mobile networks (PMNs).

As another example, the sensing signal may consist of a number of pulses sent, e.g., at specific frequencies and timing (sensing signal parameter information) by a sensing transmitter. The sensing receiver may include a number of bandpass filters that allow identifying the sensing signal parameter information, e.g, timing and frequency of the received pulses. In particular, if the transmitter determines a given pseudo-random sequence of frequency/timing pulses and beams it, e.g., by means of beamforming, in a specific direction, and if the transmitter communicates to the receiver the timing/frequency, in general, the sensing signal parameter information, of the transmitted sensing signal, the receiver can use its bandpass filters to identify the reception of the same transmitted pulses, i.e., sensing signal, based on the received sensing signal parameter information.

### Distributed Sensing Configuration and Operation

FIG. 1 schematically shows a distributed radar function created via a 5G communication system link according to an embodiment.

In this embodiment, in distinction to a purely centralized radar solution (such as mmWave) (i.e. whereby the transmitter and receiver of the radar signals is part of or operated by the same device), a part of the 5G (or other cellular or WiFi) network spectrum is configured (e.g., set into a radar mode) or is detected to be quiet/free of communication for a period of time to enable performing, e.g., remote vital signs and other measurements by construction of a distributed radar system between a base station (BS) 100 (such as a 5G base station) or UE (as transmitter) and at least one UE 120 (such as a 5G UE) or base station (as receiver), while the lack of analogue signal exchange and the additional path length caused by the transmitter-receiver distance and the distance between the receiver (e.g. UE 120) and a target (e.g., human being) may be corrected for. To this end, a base station 100 (or UE) that will act as transmitter may set up a communication link with a UE 120 (or base station) that will act as a receiver (or vice versa) to exchange some control information and/or sensing measurements and/or (partial) sensing results. The control information may include a set of configuration parameters related to the distributed sensing operation. The parameters may include e.g., distance and angle from transmitter to receiver, pulse origination time, pulse phase, frequencies, possibly including chirp timing (CT), chirp profile (CP), target location (TL), phase offset (PO), time between subsequent sensing signals, number of repetitions, sensing signal waveform information, amplitudes, MIMO/beamforming parameters, number of transmitter antennas used, transmit power, potential interference patterns, an identifier/address (e.g. IP address/URL) of a destination server and/or network function/device for sending the sensing results to (e.g. for storage or further processing), session or application related information (e.g. session identifier or application identifier), a desired accuracy for the sensing measurements, etc., and may be communicated in response (e.g. as an RRC Connection Reconfiguration message including e.g. a measurement configuration as specified in 3GPP TS 38.331 extended with sensing configuration parameters) to a request for radar (RR) (e.g. an initial Attach Request message from a UE to a base station or an RRC message or System Information as specified in 3GPP TS 38.331 from a base station to a UE, extended with a sensing request field) from the receiver side (e.g., UE 120), or may be sent to the receiver side by the transmitter side before the transmitter will start sending sensing signals (e.g., as part of a configuration/auxiliary information message/signal), or may be (partially) preconfigured on the receiver (e.g. stored in USIM or stored in a nonvolatile memory at manufacturing time), or may be configured on the receiver by means of a local application, or may be provided by the network (possibly via the transmitter or via another transmitter, or e.g. provided by an Access and Mobility Management Function (AMF), Policy Control Function (PCF), Network Exposure Function (NEF), Location Management Function (LMF), Gateway Mobile Location Centre (GMLC), or other core network function (e.g. as specified in 3GPP TS 23.501)) as part of policy/system information/RRC configuration/session configuration (e.g. upon initial registration or connection setup of the receiver to the network or a previous initial registration/connection setup). These parameters may be configured differently per application (e.g., based on the sensing target or based on the sensing algorithm). A set of parameters may be combined in the form of a sensing profile that may be identifiable e.g. by means of a profile identifier or application identifier or device identifier. After a sensing profile is sent/configured/pre-configured on a receiver, the activation of a sensing profile may be triggered by sending a signal/message to the receiver with an indicated sensing profile identifier. The sensing profile and/or the configuration parameters may also include an algorithm identifier, filter identifier or machine-learning model identifier to trigger the application of respectively a specific sensing algorithm, a filter or a machine learning model to use for analysing/processing the received sensing signals. These algorithms, filters or models may be pre-configured/stored at the receiver beforehand, or transmitted by the transmitter to the receiver (e.g. as virtual machine code, filter parameters/code or model data), for example in a separate message, or may be downloaded (e.g. as virtual machine code, filter parameters/code or model data) by the receiver based on e.g. a download URL or IP address of a server, may be configured for the application required. For example, if a precise distance measurement is required, the full set of parameters may be communicated, while if a phase-based velocity is required, only chirp parameters may be required. In some applications, the chirp parameters may be predefined and only an identifier indicating the set of chirp parameters may be exchanged. The parameters may also include a set of time/frequency resources (e.g., a semi-persistent schedule as defined in 3GPP TS 38.321) and/or time/frequency offsets in which the sensing signals are planned to be transmitted and/or when these are expected to arrive at the receiver. This information may also be provided as a time interval in which the receiver is expected to listen to incoming reflected sensing signals (e.g., as an offset to a start time or system frame number/subframe/symbol at which the signal will be transmitted by the transmitter). The start time, offset or time interval to perform the sensing by the receiver may be specified such that it starts at the start time or end time at which the first instance of the sensing signal is received by the receiver (i.e. the one received via a direct non-reflected path), i.e. reception of the first instance of the sensing signal can be used by the receiver to trigger/activate active sensing of the reflected sensing signals. The parameters may also include information about quiet periods or guard intervals that may be taken into account by the receiver device. In addition, the parameters may include information about encoded identity information or special symbol/preamble or a unique signal characteristic that can enable the receiver to uniquely identify the respective sensing signal from possible other sensing or communication signals. In order for the receiver to be able to determine which parts of the sensing signal has encoded information in it (e.g. signal identity information, timestamp of when the transmitter sent the signal), additional timing information and/or frequency information may be provided to identify start/end times or a subdivision of time intervals within the time interval for receiving a complete single sensing signal, that indicates where in the sensing signal the receiver can find the encoded information. In a similar way as for the sensing receiver, the sensing transmitter may be configured by the network (e.g. by an Access and Mobility Management Function (AMF), Policy Control Function (PCF), Network Exposure Function (NEF), Location Management Function (LMF), Gateway Mobile Location Centre (GMLC), or other core network function (e.g. as specified in 3GPP TS 23.501)) as part of policy/system information/RRC configuration/session configuration (e.g. upon initial registration or connection setup of the sensing transmitter to the network or a previous initial registration/connection setup) with parameters on how to perform the sensing (e.g., pulse origination time, pulse phase, frequencies, possibly including chirp timing (CT), chirp profile (CP), target location (TL), phase offset (PO), time between subsequent sensing signals, sensing signal waveform information, amplitudes, MIMO/beamforming parameters, number of transmitter antennas to be used, transmit power, quiet periods or guard intervals that may be taken into account, etc.) and/or which algorithm, filter, sensing profile to use and/or which destination server and/or network function/device to send the sensing results to (e.g. for storage or futher processing) and/or session or application related information (e.g. session identifier/application identifier) etc. The above mentioned parameters for sensing may also be pre-configured on the transmitter (e.g. stored in USIM or stored in a nonvolatile memory at manufacturing time), or may be configured on the transmitter by means of a local application, or may be provided by the receiver.

In order to facilitate the configuration of the above mentioned sensing parameters, a sensing receiver or sensing transmitter device may provide its sensing related capabilities to the network (e.g. a core network function, or a service (operated/offered by the network) responsible for managing and/or performing the sensing (i.e. a sensing service), or an application function for managing and/or using the results of the sensing operations (i.e. a sensing application)), to one or more base stations, or to the other device(s) involved in the distributed sensing (e.g. to the sensing transmitter device in case of a sensing receiver device) by means of a capability exchange message (e.g. as part of the request for radar message, or an RRC UECapabilityInformation message as specified in 3GPP TS 38.331, extended with some fields to denote the sensing related capabilities). The sensing related capability information may include for example device information (such as number of antennas or supported frequency ranges), wireless sensing signal processing capabilities (such as which algorithms supported, and/or whether it is capable of determining certain sensing results/goals (e.g. capable of determining a position or movement of a target object or a shape of a target object), one or more supported sensing profiles, etc.), wireless sensing signal transmission capabilities (whether this is supported and if so at which frequencies, etc.). The sensing receiver may be configured differently based on the received capabilities of the sensing receiver and/or sensing transmitter. The sensing transmitter may be configured differently and/or adapt the sensing signal based on the received capabilities of the sensing receiver and/or sensing transmitter.

The parameters to use for the configuration of the sensing transmitter and sensing receiver may depend on and be adapted based on sensing requirements that may be provided e.g. through an application function or a Network Exposure Function or other core network function/service or application, for example a sensing service or a sensing application. Such sensing requirements may e.g. identify the type of sensing results that are expected to be calculated (e.g. movement, position, shape, material, biometrics), information about one or more target objects (e.g. information about rough location, last known location, identifiable features or already known features such as size or material or shape) and/or quality of service (e.g. desired accuracy, sampling rate) and/or information about algorithms/filters to be used and/or session/application related information (e.g. application identifier or session identifier).

In FIG. 1, the base station 100 (and/or UE) determines the (rough) location or area or volume of the target 150 by emitting a series of signals, e.g., chirp signals, that may be beamformed in the direction of the target 150. The (rough) location may also be in the form of a relative position, e.g., a set of distances and/or angles relative to a reference point (e.g., the transmitter or the receiver). Optionally, e.g. before the actual radar sensing procedure is started between a transmitter and a receiver, the target angle and distance and/or target shape and/or target material/reflectivity characteristic may be determined using a location estimation radar operation and/or target shape determination operation and/or target material/reflectivity characteristic determination operation at the transmitter (e.g., base station 100), unless it is already known. This information may be stored at the transmitter and/or may be provided to the receiver and/or may be provided to a network function responsible for collecting the sensing measurements and/or (partial) sensing results and which may perform further processing on these sensing measurements/results to determine further sensing characteristics of a particular target.

Depending on the target sensing application, ahead of emitting a (chirp) signal, the precise timing of the phase and frequency (and optionally amplitude) of each individual (chirp) signal may be communicated (e.g., by using a protected standard communication signal) to the receiver (i.e., UE 120) optionally along with the location or relative position of the emitter (i.e., base station 100) and optionally rough location of the target 150. The idea of protected communication (encryption and/or integrity protection) is to make sure that only the target receiver can use this information. Based thereon, the receiver may optionally determine a path length and angle from the transmitter to the receiver and internally synthesize an analogue (chirp) signal matching the emitted (chirp) signal. Received and synthesized signals can be used for sensing purposes.

If the relative positions and exact times are known, the path length of reflected sensing signals via a target 150 can be determined and/or the target surface can be reconstructed accurately, e.g., by detecting a correct intermediate frequency (IF) signal at a mixer output when the signal is a chirp signal. Knowing the rough position of the target object and/or by detecting the angle of arrival of the incoming reflected sensing signal(s), a distance or angle between the receiver and the target object and/or the emitter and the target object may be calculated. Knowing the phase and therefore phase difference, the velocity of the target 150 can be determined based on the frequency.

If only the velocity of the target 150 is required (as opposed to its position and velocity), the transmitter can optionally avoid providing its relative position and only communicate the phases, timing and frequency of emitted sensing signal. In certain cases, only the sensing signal itself may be transmitted to the receiver so that the receiver can use that sensing signal assuming a fixed time delay to compute the IF signal from which the velocity of the target can be derived. This may be of particular interest to measure vital signs such as breath or heart rate. For instance, it may allow to measure the speed of the breast when breathing and derive from it the breathing rhythm.

In further embodiments, given good enough reflecting surface location estimation, the receiver may enable further data to be collected, such as skin conductivity.

In an example, the radar sensing capability can be achieved by the following procedures. The parameters of the sensing signals to be used in the transmitter sensing generation process, the rough location or relative position of the target and the position offset/angle from the transmitter to the receiver (e.g., UE 120) or the absolute/geographic location of the transmitter along with a future time or a set of time/frequency resources for first (and subsequent) sensing signals are determined and communicated from the transmitter to the receiver by using e.g. a protected communication signal. Alternatively, some of the parameters may also be pre-configured at the receiver or may be configured at the receiver by means of a local application or may have been sent by the transmitter or the network at an earlier time (e.g., during a previous session). Then, the communicated parameter information is (optionally) decrypted and/or verified by the receiver. Thereafter, the transmitter emits sensing signals at the stated time by using e.g. its DFT-s-OFDM signal generation process to generate the sensing signal. The receiver may listen to the sensing signals at the time/resources as indicated in the parameter information. The receiver may use its DFT-s-OFDM signal generation process to generate an internal synthetic sensing signal (e.g. chirp) matching the parameters supplied, optionally with a delay corresponding to the direct distance from the transmitter to the receiver, thereby minimizing the IF frequency generated in the receiver. The receiver may use the supplied sensing parameter information and/or the internal representation of the sensing signals to configure its RF reception frontend or signal detection unit to identify/detect the sensing signal amongst the signals received by the RF reception frontend. Upon detection and/or further processing of the received sensing signals, the receiver may determine and record/store start/end times, phase shifts, frequencies, amplitudes, signal deformations, signal strength, interference patterns, detected special symbols/preambles, encoded identity information of the sensing signals and/or timing of quiet periods between sensing signals. The receiver may use this information to further determine if the received sensing signals are actually reflected by a target object or have been received via a direct non-reflected path between the transmitter and the receiver, in order to filter out only the relevant sensing signals to extract sensing information about a target object. To this end, the receiver may calculate the expected path loss and/or timing between transmitter and receiver for direct path, and expected path loss and/or timing via indirect reflected path via the target, and use this in the determination of whether the received sensing signals are actually reflected by a target object or have been received via a direct non-reflected path between the transmitter and the receiver,. Alternatively, the transmitter may calculate the expected path loss and/or timing between transmitter and receiver for direct path, and expected path loss and/or timing via indirect reflected path via the target, and send this information to the receiver, which can then use this in the determination. The receiver may form an IF signal using (e.g., mixing) the internal synthetic ‘emitted’ sensing signal and the received sensing signal reflected at the target 150 and may perform band pass (or optionally only high pass filtering at the maximum frequency of the ADC) filtering and ADC to digitize the IF data and/or to digitize raw/filtered received reflected sensing signal data. To this end the receiver may create a compressed or uncompressed digitally sampled representation of the IF signal or the received raw/filtered reflected sensing signal(s), with a sampling frequency pre-configured at the receiver device, or a sampling frequency provided by the transmitter (e.g., as part of the sensing signal parameters). Also, information about which compression method/format to apply may be provided by the transmitter (e.g. as part of the sensing signal parameters) or pre-configured at the receiver. The digital IF signal may then be processed to yield application specific data (e.g., the output of one or more (pre-configured) algorithms or machine learning models), in this case sensing results related to the target (e.g. certain characteristics of the target such as its position, speed, shape, size, material composition etc. that may be determined after performing the respective signal processing/analysis on the received (reflected) sensing signals), or the digitized data from the receiver can be transmitted to the transmitter or a network function/device or a cloud to perform further application specific processing.

In addition to the processed or digitized data, the receiver may include identification information of the signal, sensing profile, algorithm/model, and/or the device, and may include timing and/or measurement information (e.g. arrival/end times, phase shifts, frequency, amplitude or signal deformations of the sensing signals) and/or antenna information/antenna sensitivity/MIMO configuration/beamforming configuration used by the receiver for sensing, and/or location/distance/angle related information of the receiver relative to the transmitter and/or the target, or as absolute coordinates, and/or information about the sensing application or sensing session (e.g. application identifier or session identifier).

A complete separation of transmitter and receiver in a digital radio system such as 5G implies that the receiver has no access to the analogue version of the directly emitted signal (phase, frequency), only the reflected sensing signal, and therefore cannot form the IF signal in the analogue domain. This would mean that all processing is performed on the received analogue signals (which requires a very fast ADC is to digitize the received ‘raw’ sensing signal).

Furthermore, in the proposed distributed radar sensing system, the distance to the reflecting surface of the target 150 depends on both the distances from the transmitter to the target 150 and from the receiver to the target 150 (rather than simply being twice the distance from the transmitter to the target, as in non-distributed radar systems).

The ‘minimum range’ of the measurement corresponds to the direct distance from the transmitter to the receiver. Of course, objects may be measured which lie at smaller distances from the receiver, but their indicated range will always be greater than the direct distance from the transmitter to the receiver. Equal time returns lie on spatial position ellipses (return ellipses) having the transmitter and receiver positions as their two focal points. The minimum (degenerate) ellipse with a short axis length of zero (a straight line between transmitter and receiver) has a minimum delay time, which is the time taken for radio waves to go directly from transmitter to receiver.

The receiver may receive a signal corresponding to the directly transmitted signal straight from the transmitter to the receiver (a pseudo-surface at ‘zero’ range, i.e., points on the direct line between transmitter and receiver).

Therefore, the proposed integrated distributed radar system may require a kind of clock-level synchronization between transmitter and receiver to remove ambiguity in sensing parameter estimation.

Furthermore, the auxiliary information signals (e.g., radar request and responded parameters) can be communicated between the transmitter to the receiver via an alternative communication route (using e.g. a separate band, a beam formed sub-beam directed at the receiver, or time interspersed signals between sensing signals) so that the receiver can obtain a representation of required details of the transmitted signal (e.g., precise timing, phase of the continuous (chirp) signal) in order to simulate the mixing of the transmitted and received signals to obtain an IF signal without requiring direct analysis of the analogue emitted signal. This could be done by, for example, internally generating an analogue version of the identical emitted sensing signal using the parameters supplied via the auxiliary information signal. Thus, to ensure that a correct timing is provided for this mixing of a simulated transmitter sensing signal and the actual received sensing signal, the transmitter should signal the precise timing, phase, frequencies etc. of the emitted signal to the receiver ahead of time.

Furthermore, the receiver may use the auxiliary/(pre-) configured information/parameters about the sensing signal to distinguish between a sensing signal received via a direct non-reflected path, versus reflected sensing signals. The receiver may ignore the sensing signals received via a direct non-reflected path (e.g. by ignoring the first instance of receiving the sensing signal (for example by checking the arrival time of the sensing signal, or by checking for phase shifts, frequency changes, signal deformations, amplitude changes, interference patterns that correspond to identify which of the sensing signals has been reflected or not), or may use these signals to more accurately determine its relative position/distance/angle towards the transmitter. The receiver may also use the signal received via a direct non-reflected path as further input to the signal analysis algorithm/model, e.g. as additional reference signal for IF calculation, (relative) position calculation or additional phase shift/signal deformation/frequency/amplitude calculations.

Additionally, the distance and angle from the transmitter to the receiver or the absolute/geographical position of the transmitter may be signaled as well, in order to calculate the correct positions for detected surfaces.

Finally, if the receiver (or transmitter, or both) is a hand-held device, the movements and vibrations of that device(s) may be measured by corresponding sensors, in order to subtract them from the movements and vibrations of the detected surfaces for some sensing applications.

The proposed distributed radar system between e.g. the base station 100 (as the transmitter) and the UE 120 (as the receiver and analyzer) provide the advantage that the receiver may be located more preferentially for obtaining the reflected sensing signals at higher signal strength than the transmitter (i.e. using the receiver part of the transmitter device to monitor the reflected sensing signals, e.g. as in the case of non-distributed sensing), for example it may be closer or more in the path of the reflected sensing signal, and may avoid some of the clutter from the transmitted signal.

Moreover, a single antenna may not operate in full continuous duplex mode, while the proposed distributed radar system separates the transmitter antenna from the receiver antenna.

As a further advantage, multiple receivers can be used with a single transmitter, each possibly associated with collecting vital signs from a different target (e.g., individual human being).

### Providing Target Identification Info and Discarding Sensing Measurements/Results Based on this

According to an embodiment which may be combined with any other embodiment or implemented independently, the transmitter and/or receiver and/or sensing service receive information (e.g. from an application, network exposure function, policy control function, subscription database (e.g. home subscriber service, unified data management service), identity database, authentication/authorization control function, public safety answering point, for example as part of the sensing configuration/parameters) information about one or more biometrics (e.g. heart rate signal characteristic, body shape, body absorption/reflectivity characteristic, body posture/movements, body size/mass, diseases/handicaps leading to certain identifiable characteristics, such as sleep apnea leading to breathing pauses during sleeping, asthma leading to potentially fast irregular breathing rate or gasping for breath, a limp leading to unusual body movements, tremors (e.g. Parkinson), expected body temperature pattern, heart rate variability/pattern) associated with an individual, whereby depending on whether the respective biometric is detected or not detected (e.g. by the analysis system) in the reflected sensing signals received by the receiver device or a receiver unit in the transmitter device, the sensing session may be continued or aborted, or the sensing information may be approved for further processing/storage or discarded, or a different target or receiver (20) or transmitter (10) may be selected. This is to make sure that no unnecessary sensing information is collected that may potentially be from the wrong target. The use of a transmitter device or the receiver (in particular in case of a radar sensing operation to determine biometrics or vital signs) may be restricted to authorized devices and/or devices of authorized individuals with permissions to e.g. read vital signs of a specific patient, so that patient security can be preserved.

In general, if the sensing service or sensing transmitter or sensing receiver determines that the sensing information (e.g. sensing measurements or sensing results related to a detected object) or the input/output data of the sensing signal processing do not correspond to the given information on how to identify the target (e.g. determined location is too far from the UE that the target is carrying, or the shape/size of the target is different (e.g. smaller or larger), or the biometrics do not fit with the target, or one or more sensing measurement/results are above or below certain threshold values), the sensing service or sensing transmitter or sensing receiver may discard the received sensing signal and/or discard the sensing information (e.g. sensing measurements or sensing results), and/or discard the input/output data of the sensing signal processing, and/or may not perform any further processing on these measurements, results and/or input/output data and/or may not transmit to a further processing unit. The sensing service or sensing transmitter or sensing receiver may also generate a notification message and e.g. send it to an application, application server, core network function or via/through the NEF for further processing or storage, and/or may store information about such occurrence onto non-volatile storage (such as a database), if the target is not detected (anymore).

In a slightly different embodiment, which may be combined with any other embodiment or implemented independently, the network may provide a service or run an application function or interface with an external application (e.g. through the NEF) to monitor a target (e.g. an elderly person living alone at home or e.g. a car). Such sensing service or application may provide information about a target location/area/volume and/or how to identify the target (e.g. address/location of a home in which or around which the target resides, or area/volume information (e.g. a delimited geographical area denoted by a set of coordinates, lengths, sizes, diameters) in which the target is to be sensed or is expected to be, physical characteristics of the target (e.g. size, shape, mass, material composition, biometrics associated with a target (e.g. as listed in the previous embodiment)), last known location, identities and/or locations of wireless communication devices or other devices that the target may own, encompass, include, or carry, etc.) to a sensing service, sensing transmitter or sensing receiver (possibly indirectly via a sensing service).

The sensing service, sensing transmitter or sensing receiver may also obtain information about devices (e.g. their identities and estimated location) that are in the vicinity of the target or target's address/location/home (e.g. a set of nearby base stations or UEs in vicinity (e.g. a UE placed in the person's home or UEs carried around by the person or its family, friends or neighbors) that are capable and that may be authorized (or are authorized) by the network and/or by the user of the device and/or by the target object to participate in (distributed) sensing of the intended target. The authorization information (which may also include user consent information) may be stored as part of a user's subscription (e.g. in the Unified Data Management (UDM) function of the core network) and/or as part of the sensing service and/or received from a service or application function or external application (e.g. through the NEF).

### Alert Situations and Emergency Calls

In an embodiment, which may be combined with any other embodiment or implemented independently, the information provided to the sensing service, sensing transmitter or sensing receiver (possibly indirectly via a sensing service) may further comprise a set of telephone numbers (e.g. emergency call numbers) that should be contacted in case of certain alert situations, a set of time periods (e.g. only evenings) or a set of triggers (e.g. only when person is known to be at home, e.g. by receiving a signal from a device that the person may carry) when the service should be active. These alert situations may be configured e.g. by an application or service (e.g. through the NEF), e.g. by setting one or more event triggers or criteria or threshold values related to one or more sensing parameters/results (e.g. if a certain movement is detected (e.g. a fall), if a lack of movement is detected (e.g. person may be unconscious or not sufficiently move during a day), if a detected breathing rate or heart rate is too high, etc). These alert situations may also be an integral part of the sensing service (e.g. a set of preconfigured alerts and the events that may cause the alert to be triggered) and may be selected/configured as part of a policy or subscription information, or selected by an application or another service through a communication interface. The sensing service may configure the sensing transmitter device(s) and/or the sensing receiver device(s) to be able to detect/measure the related sensing parameters and/or be able to determine (e.g. through algorithmic processing of the sensing data (i.e. sensing measurements and/or (partial) sensing results) whether a set of sensing parameters meets the configured criteria/threshold values to generate an event or alert. The transmitter and/or receiver may generate an event or alert and e.g. set up a call or send a message to a configured telephone number and/or inform the sensing service about the sensing results/event/alert, upon which the sensing service may process the received sensing results and/or verify that certain alert criteria are met and hence may trigger a message (e.g. SMS) to be sent to one or more of the indicated telephone numbers that should be contacted and/or set up a call to these numbers (e.g. initiate a 911/112 Emergency call). Such (emergency) call may include information about the location and/or other information about the target (e.g. information about the sensing results and/or which events caused the call/message to be sent). Depending on whether an alert situation is detected or not during/after processing the (raw) sensing measurements/results (e.g. by the sensing receiver, sensing transmitter or sensing service (which may be responsible for collecting and processing (raw) sensing measurement/results from the sensing transmitters/receivers to determine the sensing results), the sensing session may be continued or aborted, or the sensing information may be approved for further processing/storage or discarded, or a different target or receiver or transmitter may be selected.

According to an embodiment which may be combined with any other embodiment or implemented independently, the receiver (acting as a UE) initiates an emergency call with a public safety answering point via the (cellular) network to which it is attached, and based on location information provided/acquired during the emergency call according to local regulations (e.g. Enhanced 911), a transmitter in vicinity of the originating location of the emergency call (e.g. a base station in vicinity or a mobile phone in the vicinity or the mobile phone making the emergency call) may get instructed/configured to perform a sensing session (e.g. to sense a designated target victim or target area/volume around a victim or emergency area/volume), whereby the instructions/configuration parameters may include authorization information, information about the target (e.g. target location/area/volume or some characteristics of the target victim, e.g. if the target victim is not moving, lying on the ground, has cardiac arrest) or the context (e.g. how many people are gathered around the victim, distance between people and their devices relative to the victim, number of injured people, debris in vicinity) or an identifier or address (e.g. IP address, URL) of a destination server, network function/device or public safety answering point, or a credential (e.g. public key) to be used for encrypting the results, or requested sensing output/results such as target position or movement or vital signs. Also, one or more receivers (also if receiver is part of the same device as the transmitter) gets activated to participate in the sensing session, upon which the transmitter and receiver may perform sensing according to the other embodiments in this document).

The results of sensing operations (e.g. vital signs information or location information related to the victim(s)) are expected to be communicated securely (e.g. by using the provided credential) to the provided destination address (e.g. of the public safety answering point), but in case of emergency calls the sensing results may also be communicated without security protection. In case the sensing results are calculated at the receiver that initiated the call or are provided to the receiver by the sensing transmitter or sensing service or other sensing receiver that has calculated the sensing results, the receiver that initiated the call may provide the sensing results over the emergency connection (e.g. an emergency PDU session as defined in 3GPP TS 23.501 and TS 23.167, and extended accordingly). Note that the receiver, upon initiating an emergency connection, the UE may include not only its own location information in its request to set up an emergency connection, but also may include available sensing results, such as the location information of a target (e.g. as an absolute position (e.g. geographical coordinates) or relative position (e.g. distance/angle from the receiver), possibly formatted as a set of Universal Geographical Area Description (GAD) shapes), possibly augmented with other sensing results such as vital sign information of a sensed target (e.g. heartbeat in beats per minute or breathing rate). The UE may also include information about its sensing capabilities and/or an indication that sensing results are available or can be acquired.

The sensing results may be sent using extended Advanced Mobile Location (or AML) SMS of HTTP message(s) to the endpoint, whereby not only location information of the receiver that initiated the call, but also the location information of a target may be included, possibly augmented with other sensing results such as vital sign information of a sensed target. The message may include an indication that these are the result of a wireless sensing operation and may include information about accuracy or confidence level of the sensing results.

The sensing results may also be sent as a data or media stream, whereby the sensing results are continuously updated (e.g. sampled according to a pre-configured sampling rate, or depending on a data rate requirement or QoS parameter) and transmitted to the endpoint or whereby only the deltas/differences with previous sensing measurements are transmitted to the endpoint. In case the sensing results are calculated at the sensing transmitter, the sensing transmitter may provide the results to the receiver that initated the call, or may provide the results to a core network function (e.g. RSMF, LMF, GMLC) or may provide the results directly to a provided destination address.

The sensing results may be forwarded by an Emergency Call Session Control Function (E-CSCF) to the Public Safety Answering Point (PSAP). To this end, the sensing results may be provided via the AMF to the E-CSCF when the UE includes them during the PDU session establishment, or the E-CSCF may retrieve them via a LRF/GMLC as specified in 3GPP TS 23.167/23.273, extended for this purpose. The sensing receiver and/or other sensing receivers and/or sensing transmitter(s) and/or sensing service(s) (e.g. RSMF as described in other embodiments in this document) involved in the sensing of the target/target area may provide the sensing results to the LRF/GMLC, e.g. via the AMF/LMF that may have requested this information from the respective sensing receiver and/or other sensing receiver(s) and/or sensing transmitter(s) and/or sensing service(s). The LRF/GMLC may issue an Network Initiated Location Request (NI-LR) to a sensing service (e.g. RSMF), similarly the UE may issue a Mobile Originated Location Request (MO-LR) or another client (e.g. application function) may issue a Mobile Terminated Location Request (MT-LR) to the sensing service (e.g. RMSF), whereby the request may be extended to include information about a target to be sensed and/or sensing requirements (e.g. which sensing results, e.g. velocity, need to be calculated, and/or accuracy requirements) and/or sensing configuration information (e.g. target location/area/volume information based on the location of the UE that initiated an emergency call, or an identifier of the UE that initiated an emergency call if the location of the UE is not known and still needs to be determined) and/or capability information of one or more sensing receivers or sensing transmitters. Upon receiving one of these requests for sensing of a target, the RSMF may select and/or configure a set of sensing devices, e.g. transmitters and receivers) to participate in the sensing of the target/target area, upon which the transmitter and receiver may perform sensing according to the other embodiments in this document). The sensing results (e.g. position of the target) may be provided to the entity (e.g. GMLC/LRF) that issued or forwarded the “extended” location request to the RSMF. Alternatively or additionally, the sensing results may be stored in a shared storage, e.g. Unified Data Repository (UDR) from which the GMLC/LRF can fetch the sensing results. If the location of the UE that initiated the emergency call is used as target location, and the location of that UE is not known yet, the RSMF may first request the LMF to determine the location of that UE, after which it may use the resulting location as target location, possibly in addition to some other information, such as (pre-configured or estimated) distance between the UE and the target, or (pre-configured or estimated) information about the emergency/disaster area.

In summary, a method, apparatus and system is provided for issuing an alert based on sensing measurements/results, whereby a set of event triggers or criteria or threshold values related to one or more sensing measurements/results are configured in a sensing service, sensing transmitter or sensing receiver, and whereby the sensing service, sensing transmitter or sensing receiver initiate sensing of a target, determine (e.g. through algorithmic processing of the sensing data) whether a set of sensing measurement/results meets the configured criteria/threshold values to generate an event or alert, and whereby the sensing service, sensing transmitter or sensing receiver may inform each other or an application or application server or core network function or set up a call or send a message to a configured telephone number about the event or alert.

### Repositioning of Transmitter and Receiver

According to an embodiment which may be combined with any other embodiment or implemented independently the transmitter determines based on an estimated position of the sensing target and the (relative) position of the receiver and/or the estimated angles/distances between the transmitter, target and/or receiver and/or the size/shape of the target and/or material/reflectivity characteristic of the target that the sensing signals will not be able to reach the receiver with the desired quality (e.g. because the target is expected to obscure the receiver, the distances are too big, the target may not sufficiently reflect the sensing signal or may absorb the sensing signal too much) and may decide to reposition itself, delay sending the sensing signals (e.g.

wait until the target, the receiver or transmitter have moved to a new position), adapt the sensing signal transmission characteristics/waveform, send information/instructions to the receiver (e.g. warning signal, request the receiver to move closer or further away to the position of the target or change its angle towards the target, reconfigure its antennas, adapt the sensing signal parameters), select another receiver for sensing of the target, or send signal to another transmitter or receiver to initiate the sensing of the target. If the transmitter has a display (e.g. is a mobile phone) or is connected to a display the transmitter may show a notification, whereby the notification may show a request and/or instructions to the user to move the target to another position. Additionally or independently the receiver may determine based on the received sensing signal parameters (incl. the timing of the signals) or received information about the target (e.g. location/angle/distance, size/shape, material/reflectivity characteristics) that the receiver is not able to receive a sensing signal with sufficient quality and/or has not yet received during a certain time period after the start time a sensing signal with sufficient quality, and may decide to reposition itself, send message/information/instructions to the transmitter (e.g. warning signal, request the transmitter to move closer or further away to the position of the target or change its angle towards the target, reconfigure its antennas, adapt the sensing signal parameters, or send a sensing measurement/result that the transmitter may use to adapt the transmission of the sensing signals), send signal to another receiver for sensing of the target, or send signal to another transmitter or receiver to initiate the sensing of the target. If the receiver has a display (e.g. is a mobile phone) or is connected to a display the transmitter may show a notification, whereby the notification may show a request and/or instructions to the user to move the target to another position.

### Sensing Transmitter and Receiver Architecture

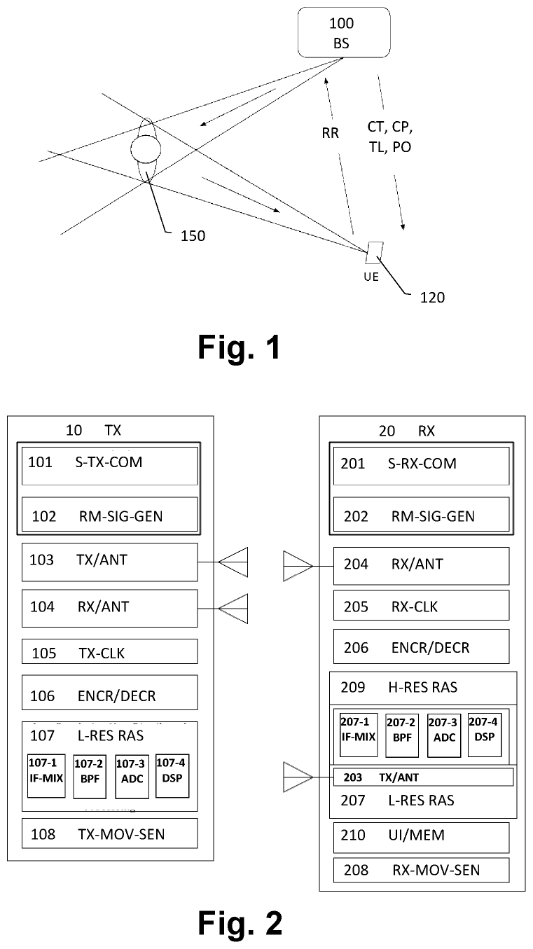

FIG. 2 schematically shows a summarizing sensing transmitter and receiver architecture (including optional elements and functions) of a communication system with distributed sensing capability according to various embodiments.

The proposed distributed radio wave sensing radar/communication system comprises a transmitter device (TX) 10 and a receiver device (RX) 20 and is configured to operate over a suitable radio frequency range (such as the initially mentioned mmWave range) and comprises RF hardware and signal processing algorithms to enable both standard communication, e.g., 5G, and radar sensing for vital signs, object detection and/or movement recognition. In 5G systems, two options for an uplink (UL) waveform are provided. One is cyclic prefix OFDM (CP-OFDM, same as downlink (DL) waveform) and the other one is discrete Fourier transform spread OFDM (DFT-s-OFDM) which corresponds to the UL waveform in long term evolution (LTE) systems (i.e., 4G). Transform precoding is the first step to create the DFT-s-OFDM waveform, followed by sub-carrier mapping, inverse FFT and cyclic prefix (CP) insertion. Whether a UE needs to use CP-OFDM or DFT-s-OFDM can be determined by a radio resource control (RRC) parameter.

A 5G transmitter or receiver with integrated radar sensing capability may have slightly modified DFT-s-OFDM and frequency domain spectral shaping (FDSS) filters enabling them to generate suitable chirps. Linear and other chirp signals can be generated with DFT-s-OFDM signals via a well-designed FDSS filter enabling standard communication hardware with only minor modification to generate suitable signals for radar. Their framework offers a way to efficiently synthesize chirps that can be used in dual-function radar and communication (DFRC) or wireless sensing applications with existing DFT-s-OFDM transceivers.

Other options for generating a signal suitable for simultaneously performing data transmission and radar sensing are described in Cong Li et al.: “Radar Communication Integrated Waveform Design Based on OFDM and Circular Shift Sequence”, Mathematical Problems in Engineering, Volume 2017 and are based on a peak-to-mean envelope power ratio (PMERP) and a peak-to-side-lobe ratio (PSLR) of OFDM waveforms. To be specific, a Gray code technology can be adopted to reduce the PMERP and simultaneously choose an optimal cyclic sequence to improve the PSLR of an OFDM waveform. The optimal cyclic sequence is dynamically generated to continuously provide the best waveform according to the change of communication data. In addition, to meet the requirements of different radar detection tasks, two simple methods can be utilized to adjust the bandwidth of the OFDM waveform. One method is to design different subcarrier complex weights and the other method is to utilize a phase code technique.

The transmitter device (TX) 10 may be an access device (e.g., base station) or a terminal device (e.g., UE or Internet of Things (IoT) device) and comprises a standard transmitter communication unit or system (S-TX-COM) 101 enabling standard communication, e.g., 5G, capabilities using e.g. DFT-s-OFDM generated data communication signals. By operating in a ‘radar mode’, the transmitter communication system 101 is capable of forming a radar mode signal generator (RM-SIG-GEN) 102 capable of e.g. generating linear chirp signals (chirps) using minimally modified communication components. This can be achieved e.g. by a using (slightly) modified DFT-s-OFDM with a suitable FDSS filter for converting the single-carrier nature of the DFT-s-OFDM signal to a linear combination of chirp signals circularly translated in the time domain, as described e.g. in Alphan Sahin et al.: “DFT-spread-OFDM Based Chirp Transmission”, IEEE Communications Letters, Volume: 25, Issue: 3, March 2021. By exploiting properties of Fourier series and Bessel function of the first kind, an FDSS filter for an arbitrary chirp can be obtained.

Furthermore, the transmitter device 10 comprises a transmission frontend (TX/ANT) 103 (e.g. capable of operating in mmWave frequencies) including a transmitter coupled to antenna with beam forming capabilities.

Optionally, a reception frontend (RX/ANT) 104 (e.g. capable of operating in mmWave frequencies) may be provided (e.g., as a separate component or integrated with the transmission frontend 103 in a joint transceiver frontend), which includes a receiver coupled to a antenna with beam forming reception capabilities (e.g., if an additional non-distributed transmitter-only radar operation is to be performed to determine a target location, shape/size or material/reflectivity characteristic).

Additionally, the transmitter device 10 comprises a transmitter clock generator (TX-CLK) 105 for generating an accurate system clock for the transmitter device 10.

Optionally, a transmitter time delay measurement functionality (not shown) may be provided (e.g., implemented by a processor/controller of the transmitter device 10), which uses the standard transmitter communication unit 101 to perform a two-way time delay measurement with a cooperative receiver device (e.g., the receiver device 20). Alternatively or additionally, the transmitter may use a non-distributed radar operation to perform sensing of a receiver device being a target, whereby the sensing results are used to calculate a distance/direction/position of the receiver device (relative to the transmitter device), and use the calculated distance to derive a time delay (e.g. a timing advance) that can be communicated to the receiver device.

Optionally, an encryption and decryption functionality (ENCR/DECR) 106 may be provided for implementing a suitable data encryption/decryption scheme (based on e.g. the Advanced Encryption Standard (AES) algorithm or the Rivest, Shamir and Adleman (RSA) algorithm) and data integrity verification (e.g., a data verification scheme using a message authentication code or digital signatures). For instance, data may be distributed in a protected radio resource control (RRC) message.

As a further option, the transmitter device 10 may comprise a non-distributed (low-resolution) transmitter radar analysis system (L-RES RAS) 107, i.e., a radar analysis system that may comprise a receiver device and/or may comprise a (low-resolution) transmitter radar analysis system, which provides a non-distributed location radar scanning capability, which may include an intermediate frequency (IF) generation mixer (IF-MIX) 107-1 to which a copy of an emitted sensing signal and an externally received reflected sensing signal are supplied and mixed to generate a mixed signal including an IF signal. Furthermore, the transmitter radar analysis system 107 may comprise electronic signal processing components—including a transmitter band pass filter (BPF) 107-2 and an analog-to-digital converter (ADC) 107-3—capable of IF filtering and analogue to digital conversion of the generated IF signal. Moreover, the transmitter radar analysis system 107 may comprise a digital signal processing component and algorithm system (DSP, implemented by e.g. a digital signal processor) 107-4 which provide DSP capabilities for e.g. location detection, preprocessing by clutter removal etc.

As a still further option, the transmitter device 10 may comprise sensor components including transmitter movements sensors (TX-MOV-SEN) 108, such as accelerometers or the like, which measure movements and vibrations of the transmitter device 10.

Furthermore, the receiver device 20 may be an access device (e.g., base station) or a terminal device (e.g., UE or Internet of Things (IoT) device) and may comprise a standard receiver communication unit or system (S-RX-COM) 201 that provides standard communication capabilities, e.g., in 5G, using e.g. DFT-s-OFDM-generated data communication signals. By operating in a ‘radar mode’, the receiver communication system 201 may be capable of forming a radar mode signal generator (RM-SIG-GEN) 202 that e.g. generates linear sensing signals e.g. by using a (slightly) modified DFT-s-OFDM signal, wherein the generated sensing signals may be used internally and not coupled to a transmitter and antenna. The waveform of the sensing signal may be generated from specific input parameters that may include at least one of a specific start time, a phase, an amplitude, a base frequency, a band width, a frequency slope, a sensing signal repetition frequency, a gap between sensing signals, and a total number of sensing signals.

Furthermore, the receiver device 20 comprises a reception frontend (RX/ANT) 204 which includes a receiver coupled to a antenna with beam forming reception capabilities, and which may be capable of operating in mmWave frequencies.

Additionally, the receiver device 20 comprises a receiver clock generator (RX-CLK) 205 for generating an accurate system clock for the receiver device 20.

Optionally, a receiver time delay measurement functionality (not shown) may be provided (e.g., implemented by a processor/controller of the receiver device 20), which uses the standard receiver communication unit 201 to perform a two-way time delay measurement with a cooperative transmitter device (e.g., the transmitter device 10). Alternatively or additionally, the receive may receive a time delay (e.g. a timing advance) from a transmitter, whereby the time delay may be calculated based on sensing results from a non-distributed radar operation to perform sensing of a receiver device being a target, whereby the sensing results are used to calculate a distance/direction/position of the receiver device (relative to the transmitter device), and use the calculated distance to derive a time delay (e.g. a timing advance) that can be communicated to the receiver device.

Optionally, an encryption and decryption functionality (ENCR/DECR) 206 may be provided for implementing a suitable data encryption/decryption scheme (based on e.g. the Advanced Encryption Standard (AES) algorithm or the Rivest, Shamir and Adleman (RSA) algorithm) and data integrity verification (e.g., a data verification scheme using a message authentication code or digital signatures) matched to the scheme(s) used on the transmitter side. For instance, data may be distributed in a protected radio resource control (RRC) message.

As a further option, the receiver device 20 may comprise a (low-resolution) non-distributed radar analysis system (L-RES RAS) 207 which provides a non-distributed location radar scanning capability, i.e., a radar analysis system that may comprises a receiver device and/or may comprise a (low-resolution) transmitter radar analysis system, which may include a transmitter frontend (TX/ANT) 204 including a transmitter coupled to a antenna with beam forming capabilities of the receiver device 20.

Additionally, the (low-resolution) radar analysis system 207 may include components which are shared with an additional high-resolution distributed radar analysis system (H-RES RAS) 209 and which may comprise an IF generation mixer (IF-MIX) 207-1, to which a (internally generated) copy of an emitted sensing signal and an externally received reflected sensing signal are input to generate a mixed signal including an IF signal, electronic signal processing components including a receiver band pass filter (BPF) 207-2 and an ADC 207-3 and capable of IF filtering and analogue to digital conversion of the generated IF signal, and an electronic and digital components and algorithm system (DSP, e.g., a digital signal processor) 207-4 which provide DSP capabilities for e.g. location detection, preprocessing by clutter removal etc.

The high-resolution distributed radar analysis system 209 may be configured to share electronics components of the IF generation mixer 207-1, which is configured to mix the inputs of an internally generated sensing signal based on supplied timing/phase parameters produced by the radar mode signal generator 202 and an externally received sensing signal supplied by the receiver frontend 204, electronic components of the receiver band pass filter 207-2 and ADC 207-3, which take an analogue IF signal, filter it with a suitable bandpass filter and perform analogue to digital conversion, and the electronic and digital components and algorithm system 207-4, which provides DSP capabilities for desired applications, including pre-processing by clutter removal etc. In order to prevent leakage/tampering of potentially privacy sensitive sensing information about a target, the radar analysis should run in a secure tamper-resistant subsystem, and the resulting sensing information should be stored on a secure storage and/or encrypted with non-tamper resistant credentials (such as subscriber identity module (e.g., USIM) credentials)

Alternatively, a final digital processing could be off-loaded from the receiver device 20 to the transmitter device 10 or to a network function/device or a cloud computing resource, which may return obtained results.

Optionally, the receiver device 20 may comprise a user Interface (UI/MEM) 210 with data storage and display capabilities, which can input information from a user, store data in the receiver device 20 and output displays to the user. Specific elements of the user interface 210 may be dependent on the type of receiver device (e.g., UE) and its function. For example, a hand-held smartphone device may have a sophisticated user interface 210 and display, while an IoT monitoring device may simply have a visual or auditory alarm.

As a further option, the receiver device 20 may comprise receiver movements sensors (RX-MOV-SEN) 208 such as accelerometers, cameras, structured light sensors, etc., which measure movements and vibrations of the receiver device 20, and locations of nearby objects.

The receiver device 20 may also communicate via its transmitter standard communication unit 201 to the transmitter device 10 its movements and vibrations by using a receiver movement data series during a sensing time interval, which have been obtained by the receiver movements sensors 208. The receiver movement data series may be sent to the transmitter by using a separate communication channel between the receiver and transmitter (e.g. as a series of RRC or MAC Control Element messages).

### Distributed Sensing Process Flow

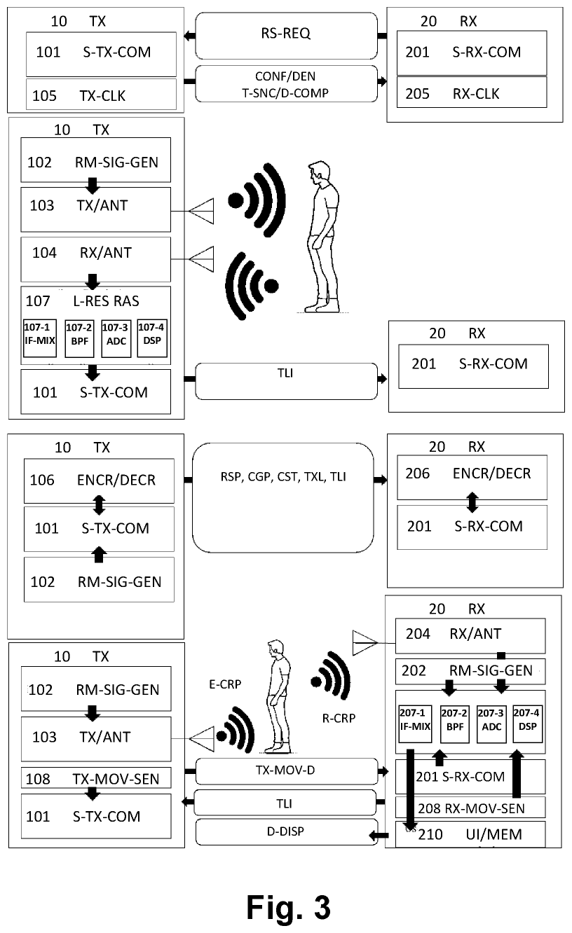

FIG. 3 schematically shows a process flow diagram for radar sensing in a communication system according to an embodiment.

In the following, a process for a distributed radar sensing function in a wireless communication infrastructure (as shown in FIG. 2) is described. The process is designed to produce a distributed system of a transmitter device 10 (e.g., base station or UE) and receiver device 20 (e.g., base station or UE) capable of both standard wireless communication and distributed radar sensing of a local environment.

In FIG. 3, the components/blocks of the architecture of FIG. 2 that are involved in the process are indicated but not described again.

The receiver device 20 uses its receiver standard communication unit 201, e.g. 5G, to transmit to the transmitter device 10 a request that a radar measurement is required (i.e., a radar service session request (RS-REQ)), optionally along with a description of its sensing related capabilities (e.g. number of antennas, supported frequency ranges, wireless sensing signal processing capabilities (such as which algorithms supported, and/or whether it is capable of determining certain sensing results/goals (e.g. capable of determining a position or movement of a target object or a shape of a target object)), one or more supported sensing profiles, etc.) and/or the position of the receiver device 20.

Alternatively or additionally, the transmitter device 10 could request a distributed radar session with a selected receiver device (e.g., UE) or multiple receivers that could be supported simultaneously.

Optionally, an initial position of the receiver device 20 may be obtained from a current known location of the receiver device 20 (if available, e.g. from a location management function in the core network) or already be known to the transmitter device 10.

Optionally, the receiver device 20 may transmit a rough indication of direction and range to a target as a target initial location estimate, which may be derivable from estimated values supplied by a user and/or based on a measurement made by a local terminal device (e.g., UE).

In an example, the receiver device 20 may also transmit a required scan time (i.e., a length of time during which a radar scanning is performed). This may depend on the desired application (for example vital signs scanning may require an extended scanning time while object location/counting may only require only a very short session (one scan)). Monitoring the position of an infrastructure object may require a short scan once per day for some extended period. The transmitter device 10 may be configured to generate sensing signals for a number of receiver devices, in which case the sensing signals are generated up to the latest required time for any of the receiver devices.

In case the transmitter has received a radar measurement request, the transmitter device 10 determines if it can respond to the request from the receiver device 20 and may transmit to the receiver device 20 a radar session confirmation (CONF) or a radar session denial (DEN) message. It may be unable to provide radar capabilities if, for example it is unable to make available sufficient bandwidth for the radar signals given its current communication demands, or if it is currently performing a radar function for another receiver device and cannot perform both, or if the receiver device 20 does not have permission to request a radar function from the transmitter device 10.

If the receiver device 20 asks for resources, the transmitter device 10 may also indicate its allocated resources. This option may be implemented similar as a dynamic resource allocation process in 5G or other standard communication systems. Thus, the receiver device 20 may send to the transmitter device 10 a resource scheduling message requesting the scheduling of radar session resources, and the transmitter device 10 replies to the receiver device 20 with a downlink control information (DCI) message including the allocated resources (e.g., time (timeslot, slot offset k2, . . . ), frequency, etc.).

Alternatively, if the receiver has not asked for resources or if the radar measurement is initiated by the transmitter, the transmitter device 10 may voluntarily send the allocated resources for radar based sensing to the receiver device. To indicate that it involves radio resources for radar based sensing a dedicated DCI message may be used that may include some of the auxiliary/configuration information (for sensing).

For sensing, it may make sense to use a semi-persistent scheduled resource allocation in which the transmitter device 10 sends the allocated resources for the radar session in a secure RRC message, reserved on a regular basis for a given period of time. If in addition an offset and/or time interval for radar based sensing is sent to the receiver device, e.g. as part of the semipersistent resource schedule or same RRC message or as a different message, then the start of the radar based sensing may be activated/triggered at the receiver by the transmitter by sending a subsequent DCI message with the corresponding Semi-Persistent Scheduling C-RNTI to the receiver.

Once resource scheduling is performed, the receiver device(s) 20 are aware of the timing/frequencies used for the (distributed) radar functionality.

Optionally, a time synchronization (T-SYNC) and delay compensation (D-COMP) measurement process may then be initiated, where the transmitter and receiver clocks are synchronized. This may not be necessary for applications where a high level of clock synchronization for sensing or distance measurements (i.e. ranging) is not required.

This measurement process may be achieved by having the transmitter device 10 send a timing signal (clock synchronization signal) that reflects the current timing of the transmitter clock to the receiver device 20 using its standard communication unit, and by having the transmitter device 10 perform a round trip time delay measurement from the transmitter device 10 to the receiver device 20 and back using the transmitter time delay measurement functionality and with the receiver device 20 using the receiver time delay measurement functionality resulting in a measured delay time (transmitter-receiver delay), and by having the receiver device 20 update the receiver clock time using both the clock synchronization signal and the transmitter-receiver delay, thereby ensuring that the two clocks of the transmitter device 10 and the receiver device 20 are completely synchronized. Alternatively or additionally, the transmitter device 10 may use a non-distributed radar operation to perform sensing of a receiver device 20 being a target, whereby the sensing results are used to calculate a distance/direction/position of the receiver device 20 (relative to the transmitter device 10), and use the calculated distance to derive a time delay (e.g. a timing advance) that can be communicated to the receiver device, which can then use this information to synchronize its clock.

As an optional measure, the transmitter device 10 may then obtain a (relative) position, shape/size or material/reflectivity characteristic of a desired target to direct its transmitter towards that location. This can be achieved by at least one of:
(i) having the receiver device 20 (or a core network function, e.g. a sensing management function, or an application server (e.g. via a Network Exposure Function), not shown in the figure) send to the transmitter device 10 the position of the target obtained from an initial target location estimation which may have been obtained by a user entering details of the target position, or some other form of relative location estimation performed by the receiver device 20; or
(ii) as shown in FIG. 3, having the transmitter device 10 perform a low-resolution scan of the environment and select a suitable target direction for detailed radar transmission, where the radar mode signal generator 102 sends sensing signals via the transmitting frontend 103, reflected sensing signals are received by the receiving frontend 104, and the transmitter low-resolution non-distributed radar analysis system 107 is used to process the signal (e.g., a standard

FMCW scan using a sweep of beam forming directions to determine approximate surfaces in the scene and obtain a target location information); or
(iii) having the receiver device 20 perform a low-resolution scan of the environment and select a suitable target direction for the detailed radar transmission, wherein the radar mode signal generator 202 sends sensing signals to the transmitting frontend 203, reflected sensing signals are received by the receiving frontend 204, and the receiver low-resolution non-distributed radar analysis system 207 is used to process the signal (e.g., a standard FMCW scan using a sweep of beam forming directions to determine approximate surfaces in the scene and obtain a target location information which is then communicated to the transmitter device 10); or
(iv) having the transmitter device 10 identify a device carried/encompassed by the target subject (e.g. matching the identity of a known device in a device database) by using the signals/communication messages received from that device through the receiving frontend 104 of the transmitter device, and use the measurement or location information of that device (e.g. provided by the device or by a location service) to determine a rough location of the sensing target. In a particular example, the target sensing subject (e.g., a person) is carrying a receiver device 20 that can also be used for performing the distributed radar sensing measurements; or
(v) having the transmitter device 10 receive information from a sensor, camera or surveillance system (e.g. capable of generating heat maps or process video footage) and/or through an external application interface (e.g. Network Exposure Function) about potential target subjects for radar based sensing; or
(vi) having the transmitter device 10 use CSI information received from a set of devices in an area and use this to calculate changes and/or interruptions/occlusion of certain signals to detect some activity/movement of an object in the area, and use that to determine a rough location of a potential sensing target; or
(vii) having the transmitter device send an initial set of signals (possibly at different frequencies, varying waveforms, varying bandwidth, and various beam steering directions/angles/focal areas) and receive reports from a set of receiver devices 10 that have received one or more of these signals, including timing information of receiving the signal(s), and processed information regarding these signal(s), such as IF signal information or angle of arrival, and using the information from these reports to determine a rough location of a potential sensing target.

Then, the transmitter device 10 selects an appropriate transmitter target direction for beam forming for the distributed radar function from the target location information.

Furthermore, the transmitter device 10 selects appropriate parameters of the sensing signals to be generated for the distributed radar function. The sensing signal generation parameters may be chosen to meet at least one of bandwidth/frequency constraints at the transmitter device 10, limits on the sensing signal generation capabilities of the radar mode signal generator 102, and requirements of the radar application e.g. as requested by the receiver device 20. Such sensing signal generation parameters may include at least one of a number of sensing signals (related to the scan time and application requirements), a sensing signal repetition rate (alternatively, a delay between chirps), a sensing signal frequency slope, a sensing signal bandwidth, a lowest sensing signal (starting) frequency, an initial sensing signal phase, and a sensing signal start time (precise time for the first sensing signal, that may be selected at a later time).

Further details about the relationship between sensing signal parameters and accuracies of positioning and velocity (as well as the use of triangular chirp signals rather than linear chirp signals) can be gathered from e.g. Pasi Koivumäki: “Triangular and Ramp Waveforms in Target Detection with a Frequency Modulated Continuous Wave Radar”, School of Electrical Engineering, Espoo 23/01/2017.

Before or thereafter, the transmitter device 10 uses its transmitter standard communication unit 101 (e.g., 5G) to send receiver configuration information such as at least one of radar session parameters (RSP), the sensing signal generation parameters, the sensing signal start time (CST), the transmitter location (TXL, own location of the transmitter device 10), and the target location information (TLI) and other information about the target (e.g. shape/size, material/reflectivity characteristic) to the receiver device 20, e.g., as part (e.g. an encrypted payload) of an RRC message, such as a measurement configuration included in the RRC Reconfiguration message or the RRC Resume message).

The transmitted receiver configuration information is received by the receiver standard communication unit 201 (e.g., 5G) and (optionally) decrypted and verified at the receiver device 20 using a suitable process (e.g., decryption algorithm).

It is noted that any of the data exchanges in any of the methods described herein may be protected between the transmitter device 10 and the receiver device 20, where protected can mean integrity protected and/or encrypted. The integrity protection may be required to make sure that an attacker cannot tamper with the required radar parameters, e.g., the chirp generation parameters. The encryption may be required, e.g., to make sure that an attacker located close by to the receiver device 20 cannot use the transmitted signal to monitor the target.

Optionally, if specific ranging and positioning is required, the receiver device 20 may derive a relative position offset (or alternatively distance and angle) between the transmitter device 10 and the receiver device 20 and/or an equivalent time delay (transmitter-receiver delay) by at least one of using the transmitter location plus its own known receiver location to calculate the relative position offset (and equivalent light transit time) between the transmitter device 10 and the receiver device 20, or determining from a round trip delay measurement from the receiver device 20 to the transmitter device 10 and back the time delay using the receiver time delay measurement and with the transmitter device 10 using the transmitter time delay measurement, or re-using the above obtained transmitter-receiver delay.

This relative position/distance/time delay can be used to derive the time at which the transmitter sensing signal is to be emitted and received, and in subsequent digital signal processing to enable knowledge of the points in the environment or scene, which lie on spatial ellipses of equal delay time defined by the transmitter device 10 and the receiver device 20 as focal points.

The relative position/distance/time delay information provided to the receiver can also be used to delay/trigger the start time of an active sensing time interval at the receiver, e.g. such that only reflected signals are sensed/received and taken into account for the sensing algorithm, and not the first signal that reached the receiver through a direct path without reflections (given the longer path and hence longer delay/later signal arrival time of the reflected sensing signals compared to the shorter path and hence shorter delay/earlier arrival time of the direct sensing signals). To this end, the signals received before a certain time (e.g. based on the estimated distance/delay for a signal travelling directly between the transmitter device and the receiver device) may be ignored/discarded, and only those signals that arrive after a time beyond the estimated delay for the direct path will be used for further analysis.

At the sensing signal start time, the transmitter device 10 uses the radar mode signal generator 102 operating on the sensing signal generation parameters and emits a sensing signal or a sequence of sensing signals (E-CRP) with an antenna beam formed in the direction of the target (i.e. transmission target direction).

The transmitter device 10 may also communicate via its transmitter standard communication unit 101 to the receiver device 20 its movements and vibrations by using transmitter movement data series (TX-MOV-D) during a series of sensing signal transmissions or sensing interval (e.g., a chirp sequence transmission), which have been obtained by the transmitter movements sensors 108. The transmitter movement data series may be sent along with the sensing signal (e.g. encoded in the signal) or by using a separate communication channel between the transmitter and receiver (e.g. as a series of RRC or MAC Control Element messages).

The receiver device 20 receives reflected sensing signal (R-CRP) by calculating the direction to the target and/or the expected delay for the signal to arrive via a path reflected via the target from the target location information supplied to it by the transmitter device 10. Alternatively, the receiver device 20 can search for the radar reflections until it finds a desired signal, e.g., a signal that corresponds to the (pre-)configured/received sensing signal characteristics (e.g., waveform, frequency, preamble, encoded identity, . . . ), or the maximum returned signal, or which corresponds to a certain pattern (based on the application) in the reflected sensing signals (e.g. that may be indicative/representative of a vital sign or movement of an object), and use this direction as the receiver target direction.

Alternatively, if the receiver device 20 allows a number of sensing signals to be transmitted before analysis can begin and/or the beamformed radar transmission direction is not known to the receiver device 20, it can scan the environment or scene using beamforming and detect a direction giving the highest sensing signal returns and store this as receiver target direction.

The receiver device 20 then directs its antenna of the receiving frontend 204 using beamformed reception at the receiver target direction and collects reflected radio signals to form the received signal.

Then, the receiver device 20 may starts an IF signal generation process by using the sensing signal generation parameters and optionally the sensing signal start time and the transmitter-receiver delay to generate an internal analogue signal (i.e., a synthetic sensing signal that precisely matches the emitted sensing signal) by its radar mode signal generator 202. It may combine this internal analogue signal with the received signal in the IF mixer 207-1 to generate an IF signal. Options for this signal combination can be that the synthetic sensing signal is timed to match the sensing signal start time (exact time that the sensing signal is emitted by the transmitter device 10) or that the synthetic sensing signal is timed to match the time when the sensing signal will arrive at the receiver device 20 by a direct path (that is, the synthetic sensing signal time is equal to the sensing signal start time plus the transmitter-receiver delay), or that the synthetic sensing signal time is equal to the sensing signal start time plus some defined fraction of the transmitter-receiver delay.

A reason for adding the transmitter-receiver delay (or some fraction of the delay) can be to obtain a minimum range (i.e., minimum IF frequency) that is zero (or some minimum value) rather than representing the distance to the transmitter device 10, to thereby reduce the IF frequencies and increase the available range of detection (by reducing the ‘measured range’ of detection).

In an example where an object is to be positioned exactly, it is assumed that the transmitter device 10 can also receive radar signals (i.e., it comprises a non-distributed radar as well) and thus estimate a distance D1 to any object because of the usage of e.g. an FMCW radar. The receiver device 20 knows exactly when the transmitter device 10 starts sending a sensing signal and can estimate the distance D2 from transmitter device 10 to receiver device 20 through the reflected path. In this case, the distance D3 from receiver device 20 to the object can be calculated as D3=D1ΔD2. Thus, if the locations of the receiver device 20 and the transmitter device 10 are known (e.g., in case of a distributed access device (e.g., gNB-DU)), then this embodiment could be used to enhance positioning algorithms

Similarly, if the transmitter device 10 can receive radar signals and is able to accurately calculate the distance D1 and/or angle A1 between the transmitter and the sensing target, and forwards this information together with its own (relative) position information, then the receiver device can use this information together with information of the received sensing signal via a direct non-reflected path (i.e., typically the first instance of a series of sensing signals) and via a reflected path to accurately calculate the distance between the receiver and the transmitter, or its position relative to the transmitter, or its absolute geographical position, more accurately.

Additionally to other embodiments or independently from other embodiments, if the transmitter device 10 can receive radar signals and is able to accurately calculate the distance D4 and/or angle A4 between the transmitter and the receiver device, e.g. by directing the radar sensing and beam forming towards the receiver device, and transmits D4 and/or A4 (possibly together with position information of the transmitter) to the receiver device, the receiver device can use this information to calculate its position or e.g. use it to verify or further improve the accuracy of distance D4 and/or angle A4 or detect movement of the transmitter relative to the receiver by correlating the received distance D4 and/or angle A4 with the sensing signals it may receive itself from the transmitter via a direct non-reflected path, or verify or combine it with distance measurements obtained through other means, such as performing TDOA-based distance/position estimation between the transmitter device and the receiver device. In other words, a method is provided for distance and/or angle measurement between a transmitter and a receiver device, whereby the transmitter uses radar based sensing to determine a distance and/or angle between itself and a receiver device, transmit the determined distance and/or angle to the receiver device, whereby the receiver device may use the received distance and/or angle from the transmitter device to verify/correlate it with a distance and/or angle determined based on other means (such as a distributed sensing measurement/result, ranging (e.g. using TDOA or Round-Trip Time measurements) or GNSS position of the receiver and/or transmitter), and/or to determine a geographic location (of the receiver or transmitter) or relative coordinate (e.g. distance/angle between receiver and transmitter, or using a relative coordinate system using a reference point, e.g. receiver having coordinate (0,0,0)) and/or detect movement of the transmitter relative to the receiver.

In those examples where either the transmitter device 10 or the receiver device 20 optionally comprise a non-distributed radar, positioning information may also be derived from alternative positioning or ranging technologies, e.g., 5G positioning or ranging technologies, such as round-trip time, angle of arrival, time of flight, etc. enabled by means of, signals, e.g., positioning signals through either standard Uu interface or the PC5 (sidelink) interface.

Following the generation of the IF signal in the IF mixer 207-1 of the receiver device 20, the signal is band-pass or low-pass filtered and converted to a digital signal using the filter and ADC components 207-2 and 207-3. The IF signal is high-pass filtered (as part of the band pass filter) if the use of the IF data requires removing returns (reflected chirp signals) below some minimum ‘range’ (distance from the transmitter device 10 to the target and return to the receiver device 20). Furthermore, the IF signal can be low-pass filtered to prevent aliasing at the upper frequency range of the ADC 207-3.

The resulting digital data obtained from the ADC 207-3 may be processed using the digital signal processing system 207-4 to yield sensing information (e.g. sensing measurement/results or application specific data). Alternatively, the digital signal processing can be dispensed with by communicating the resulting digital data to the transmitter device 10 (e.g., as an RRC measurement report) or network function/device (e.g. through a NAS message or User Plane message). The processed received sensing signal and/or the digital data and/or the sensing measurements/results and/or application specific data and/or other sensing information/results may be transmitted to the transmitter device 10 or a cloud computing resource, e.g., an edge server, which may return the processing result to the receiver device 20.

Optionally, the receiver device 20 may send an updated and improved target location information (TLI) and/or location/movement/vibration information of the receiver device (e.g. as acquired by its movement sensor 208) to the transmitter device 10 during the radar process based on the results of the above digital signal processing, using standard (e.g., 5G) communication between the receiver device 20 and the transmitter device 10, to enable continuing accurate beamforming by the transmitter device 10 towards the target or to adjust the beamforming by the transmitter device 10 towards the target, or to adjust the sensing signal sent by the transmitter device 10, or to adjust the sensing signal configuration information to be used by the transmitter device 10 and/or to be sent to receiver devices, or to update the location information of the target and/or the receiver by the transmitter device 10, based on the target location information and/or receiver location/movement/vibration information and/or the processed sensing signal and/or the resulting digital data and/or the application specific data and/or other sensing information/results received from the receiver device 20 during the course of the distributed radar process.

It is noted that the receiver device 20 may have limited information on the exact position of the target due to reflected sensing signals of equal delay time lying on spatial ellipses (restricted to some extent by the beam width of the transmitted signal). A target object may be moving to the edge of the transmitter beam, so that the transmitter device 10 may need to update its transmitter target direction.

Optionally, a movement compensation may be performed, where detected movements of the transmitter device 10 and/or the receiver device 20 are subtracted during data processing, wherein the receiver movement sensors 208 obtain sensor signals (movement data series) of the movements of the receiver device 20 and the transmitter movement sensors 108 obtain movements of the transmitter device 10.

Finally, input information may be collected and the resulting digital data (D-DISP) may be stored and displayed by the receiver device 20 using its user interface and data storage 210. The precise nature and details of the user interface, data storage and display process may depend on the type and nature of the receiver device 20 (e.g., UE) and may range from a high-resolution display with sophisticated user interface to a very simple number display or generation of an alarm.

### Distributed Sensing Flow Diagrams

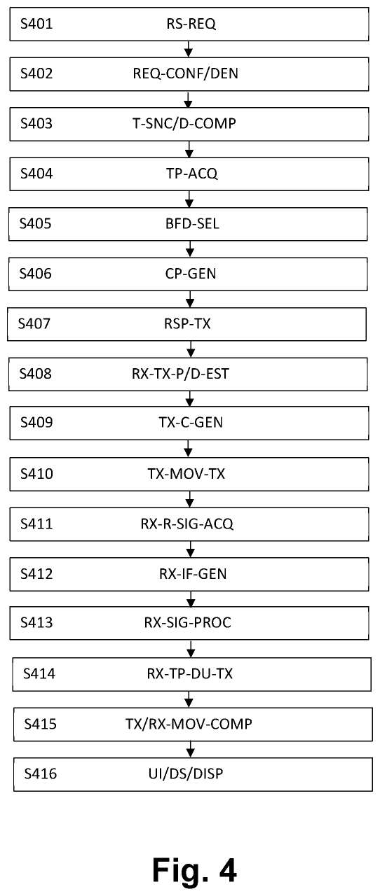

FIG. 4 schematically shows a flow diagram of a sensing operation, e.g., a radar-based sensing operation, between a transmitter device and a receiver device according to an embodiment.

In an optional initial session request step (RS-REQ) S401, a receiver device (e.g., access device or terminal device) may use wireless communication to transmit a sensing/service session request (e.g., using an RRC message) along with information about the position of the receiver device to a transmitter device (e.g., access device or terminal device) to inform the transmitter device that a measurement is required. Optionally, an initial target location estimate plus the required scan time may be supplied as well by the receiver device.

In an optional responsive request confirmation/denial step (REQ-CONF/DEN) S402, the transmitter device determines if it can respond to the request (for example make available sufficient bandwidth for the signals given its current communication demands) and transmits to the receiver device a confirmation or denial response.

Alternatively, the transmitter device can look up potential receiver devices close to the intended target (e.g. by requesting the last known position from a location database/service, or by requesting the potential receiver devices to send their known position information, or acquiring the position from the potential receiver devices through trilateration/triangulation/round trip time calculations based on signals received from the potential receiver devices) and can voluntarily requests a receiver device to be used for sensing.

Then, a time synchronization and delay compensation step (T-SYNC/D-COMP) S403 is initiated, where a receiver clock is synchronized to a transmitter clock by sending a timing signal to the receiver device.

In a subsequent optional target position acquisition step (TP-ACQ) S404, a target location information is determined by the transmitter device, e.g., by performing an approximate radar object location scan in the direction indicated by the receiver device as target initial location estimate.

Then, in a transmitter beamforming direction selection step (BFD-SEL) S405, the transmitter device selects an appropriate direction (for beamforming) for a distributed sensing function based on the target location information as transmitter target direction.

In a following signal parameter generation, e.g., chirp parameter generation step (CP-GEN) S406, the transmitter device selects appropriate parameters of the signals and generates matching parameters for signal generation (e.g., by DFT-s-OFDM processing).

Then, in a subsequent (radar-based) sensing session parameter transmission step (RSP-TX) SD407, the generation parameters and/or a selected start time and/or the location of the transmitter device and/or a target location information are protected, e.g., encrypted using an encryption algorithm, and sent to the receiver device where it is decrypted using a corresponding decryption algorithm.

In a following receiver-transmitter relative position and delay estimation step (RX-TX-P/D-EST) S408, the receiver device uses the transmitter location plus its own known receiver location or a round trip delay measurement to calculate a relative offset (and equivalent light transit time) between the transmitter device and the receiver device.

At the signal (e.g., chirp) start time, the transmitter device initiates a transmitter generation step (TX-C-GEN) S409 and generates and emits a signal or a sequence of signals based on the generation parameters via an antenna beam formed in the direction of the transmitter target direction.

In an optional transmitter movement series transmission step (TX-MOV-TX) S410, the transmitter device communicates its detected movements and/or vibrations during the sequence to the receiver device as transmitter movement data series.

In a receiver reflected signal acquisition step (RX-R-SIG-ACQ) S411, the receiver collects reflected radio signals using beamformed reception directed at the target, to obtain a received signal.

The above steps S401 to S411 can also be applied to CSI-based distributed sensing systems, where the procedure may end here.

The following steps S411 to S416 may be added for radar/chirp-based distributed sensing systems.

In an optional receiver IF signal generation step (RX-IF-GEN) S412, the receiver device uses the obtained sensing signal start time, transmitter-receiver delay and sensing signal generation parameters to generate a synthetic internal analog sensing signal that matches with the emitted sensing signal and mixes this signal with the received signal to generate an IF signal. Additionally or alternatively, the receiver may perform measurements (e.g. determine time of arrival of a received sensing signal, determine an angle of arrival of a sensing signal, determine an amplitude or frequency of a signal) or perform digital signal processing of the received sensing signals (e.g. to perform filtering of the signal, such as band-pass filtering or determine a signal deformation).

In a subsequent optional receiver signal processing step (RX-SIG-PROC) S413, the resulting IF digital signal data, or the output resulting from measurements and/or digital signal processing performed on the received sensing signals is processed to yield sensing information (e.g. sensing measurements/results or application specific data, e.g., target location, movement, vibration etc.). Additionally or alternatively, the resulting IF digital signal data or the output resulting from measurements and/or digital signal processing performed on the received sensing signals and/or the yielded sensing information is transmitted to a sensing service or a transmitter device for further processing.

Furthermore, in an optional receiver target position update transmission step (RX-TP-UD-TX) S414, the receiver device may send an updated and improved target location information to the transmitter device based on the results of step S413 to enable continuing accurate beamforming by the transmitter device towards the target.

Additionally, an optional transmitter and receiver movement compensation step (TX/RX-MOV-COMP) S415 may be integrated, where measured movements and/or vibrations of the transmitter device and the receiver device are subtracted from motions detected by the radar.

Finally, in a user interface, data storage and display step (UI/DS/DISP) S416, the resulting data is stored and displayed by the receiver device and input information is collected (when necessary) using the user interface.

In the following additional embodiments, details of the application-specific processing applied to the digitized IF signal (e.g., in step S413 of FIG. 4) are described.

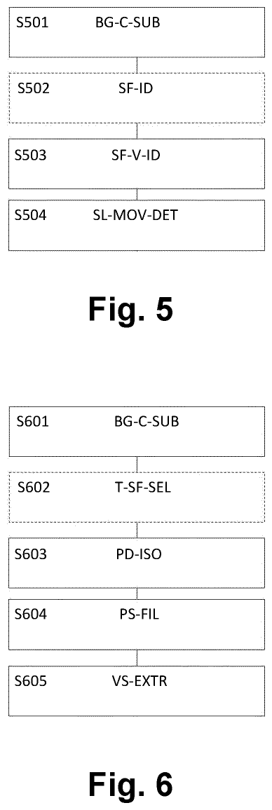

FIG. 5 schematically shows a flow diagram of a location and movement detection process according to an embodiment.

This embodiment may be relevant for use cases such as object counting, object motion detection and measurement, infrastructure monitoring and the like. In such cases, the receiver device or transmitter device may request to set up a process for regular radar operations, e.g., repeated radar sensing every 15 minutes.

In an initial background clutter subtraction step (BG-C-SUB) S501, background subtraction of clutter (e.g., undesirable multipath signals) from the digital IF signal (i.e., IF frequency data) is performed. Background subtraction may be achieved by discriminating foreground information from background information based on variations of received data at different times. This can be achieved by applying recursive moving averaging (RMA) or a Gaussian mixture model (GMM) for learning mean values of path distributions.

Then, in a surface identification step (SF-ID) S502, individual surfaces are identified from constant lines detected in the IF frequency data.

For objects with a measurable velocity, the velocity of each isolated surface is identified in a surface velocity identification (SF-V-ID) step S503 by the average phase change of the data extracted from that surface over several sequential sensing signals after phase extraction and phase unwrapping, e.g., by applying Doppler FFT. A sensing signal reflected at a moving surface incurs a Doppler frequency shift which is proportional to the velocity of the surface. This frequency shift introduces a phase shift in the detected sensing signal.

For objects with slow and long-term movement, the movement can be found in a slow movement detection step (SL-MOV-DET) S504 by determining their locations (range, direction) at regular times and calculating a change of that location over time.

FIG. 6 schematically shows a flow diagram of a heart rate and breathing rate detection process according to an embodiment.

Again, in an initial background clutter subtraction step (BG-C-SUB) S601, background subtraction of clutter from the digital IF signal (i.e., IF frequency data) is performed.

Then, in a target surface selection step (T-SF-SEL) S602, the correct surface for a targeted user is selected from a constant line in the IF frequency data (at correct range).

In a subsequent phase data isolation step (PD-ISO) S603, the phase data from the selected surface is isolated and phase unwrapped (e.g., by applying a Doppler FFT). Alternatively, the phase can be represented by complex components of sine and cosine of the signal (which avoids the need for phase unwrapping).

Then, in a phase filtering step (PS-FIL) S604, the phase signal is band pass filtered for a heart rate frequency range (e.g., 0.6˜4 Hz) and/or a breathing rate (e.g., 0.1˜0.6 Hz) to derive a heart rate data and/or a breathing rate data.

Finally, in a vital signal extraction step (VS-EXTR) S605, the resulting data is processed to extract the vital sign signal from the noise, for example using an algorithm such as a deep neural network trained on a dataset collected along with a ‘gold standard’ such as electrocardiogram (ECG) and/or stretch breathing sensors, to compensate for noise and background movements to extract the desired signal (heart rate, breathing rate), the signal variability (e.g. heart rate variability) and confidence values for the accuracy of the data values.

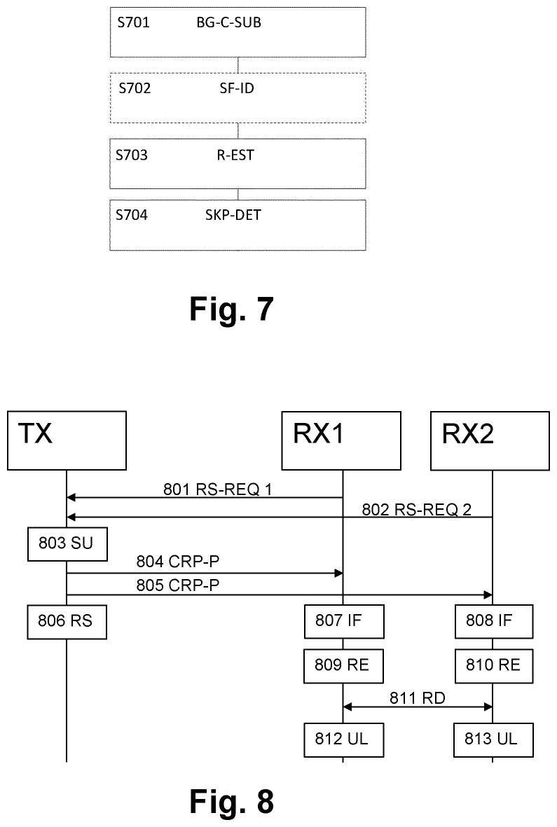

FIG. 7 schematically shows a flow diagram of a skin conductivity measurement process according to an embodiment.

Again, in an initial background clutter subtraction step (BG-C-SUB) S701, background subtraction of clutter from the digital IF signal (i.e., IF frequency data) is performed.

Then, in a subsequent surface identification step (SF-ID) S702, individual surfaces are identified from the constant lines in the IF frequency data.

In a subsequent reflectivity estimation step (R-EST) S703, the total reflectivity of a selected surface is estimated from the amplitude of the surface IF signal.

The obtained total reflectivity is then compared to a dataset of surface values in a skin permittivity determination step (SKP-DET) S704 to obtain a corresponding skin permittivity value for the mmWave frequencies used.

A small spectrum of values can be calculated for the IF amplitude of the surface over the course of the sensing signal as the mmWave frequency changes during that time.

Embodiments which include several receiver devices (as UEs, base stations or a mixture of these) may cooperate in a radar sensing process by receiving reflected radio waves from at least one transmitter device and jointly perform operations as described in the above embodiments for a single receiver device.

### Multi-Receiver Distributed Sensing

FIG. 8 schematically shows a signaling and processing diagram of a radar sensing process in a multi-receiver system according to an embodiment. The signaling and processing diagram indicates an information exchange between system components as an arrow and a processing step executed by a component as a block positioned below the respective component, while the time proceeds from the top to the bottom of FIG. 8.

In steps 801 and 802, first and second receiver devices (RX1, RX2) both request a radar session by signaling respective radar session requests (RS-REQ 1, RS-REQ 2) to a transmitter device (TX). Alternatively, only the first receiver may send a request in step 801 to the transmitter device. The transmitter device can look up other suitable receiver devices close to the first receiver and/or the intended target. Thus, one of the receiver devices (e.g., Rx1) sends the request and the transmitter device determines the second receiver device (e.g., Rx2) and responds in step 805 without requiring the request in step 802.

Alternatively, the transmitter device can look up potential receiver devices close to the intended target (e.g. by requesting the last known position from a location database/service, or by requesting the potential receiver devices to send their known position information, or acquiring the position from the potential receiver devices through trilateration/triangulation/round trip time calculations based on signals received from the potential receiver devices) and can voluntarily requests a first and second receiver device to be used for sensing.

In step 803, the transmitter device performs any required set-up (e.g., clock synchronization, target position estimation, transmitter/receiver position difference, etc.) for each of the receiver devices (e.g. using the mechanisms as described in other embodiments).

Then, in steps 804 and 805, the transmitter device signals to both receiver devices the signal parameters, e.g., chirp parameters, (CRP-P) and timing information. It can also be that the signal parameters in steps 804 and 805 are sent without a request from any receiver device (e.g., if the receiver devices are part of an infrastructure).

In step 806, the transmitter device performs a sensing operation, e.g., a radar sensing operation, by emitting sensing signal(s), e.g., chirp signals, in line with the signaled signal parameters and timing information (e.g. using the mechanisms as described in other embodiments).

In steps 807 and 808, the receiver devices sense sensing signals, e.g., reflected at a common target. The receiver devices then process the received reflected sensing signals for sensing purposes (e.g. using the mechanisms as described in other embodiments, for instance, in the case of a chirp signal the receiver devices may calculate an IF signal using the received reflected chirp signals and an internally synthesized chirp signal matching the transmitted chirp signal).

Then, in steps 809 and 810, a sensing processing, e.g., radar processing (e.g. as described in other embodiments), may be performed at each of the receiver devices, e.g., to generate range ellipses (RE) based on the IF frequency data obtained in steps 807 and 808 and the transmitter/receiver position difference signaled from the transmitter device or obtained at the receiver devices.

Following this, the receiver devices may exchange with each other in step 811 their derived data (RD) (for example the digitized IF data obtained using synchronized clocks along with the radar setup parameters such as distance and angles to the transmitter device or the derived range ellipse data). Based thereon, the receiver devices may detect in steps 812 and 813 a unique spatial location (UL) of a target and/or surface e.g. by finding intersections of their ranging ellipses and constraining the position by the direction angle of the transmitter beam and the beam spread angle of the transmitter beam. Alternatively, the receiver devices may send their RD to the transmitter device TX (e.g., a base station) or a sensing service in the core network so that the transmitter device TX or sensing service derives the sensed data, e.g., related to the location.

In an example, the transmitter device or the core network may require a network function with a database storing the identities of the receiver devices and their locations.

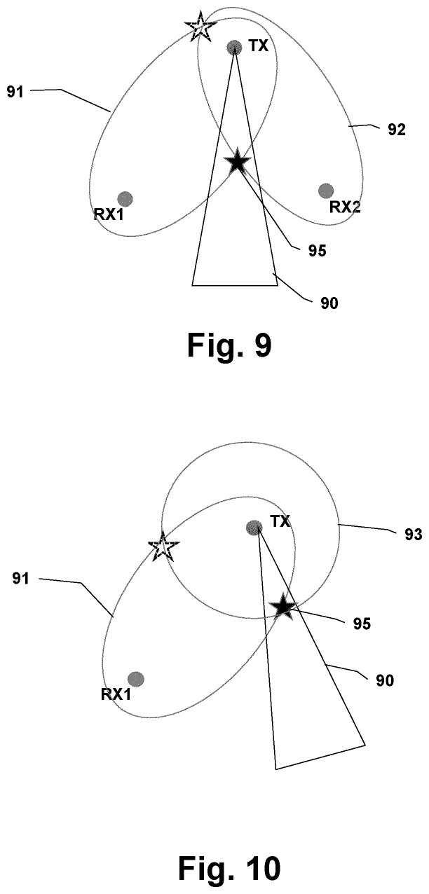

FIG. 9 schematically shows an example of an improved position location estimation with one transmitter device TX and two receiver devices RX1 and RX2 according to an embodiment.

The measured IF signals at the two receiver devices RX1 and RX2 provide a first equal-distance return ellipse (range ellipse) 91 for the first receiver device RX1 and a second equal-distance return ellipse (range ellipse) 92 for the second receiver device RX2. The two range ellipses 91, 92 provide two intersection points indicated by respective star-shaped markers in FIG. 9.

However, in the example of FIG. 9, only one of the intersection points is selected as target location 95, since it meets the following three criteria that define a unique target location:
1) located on return ellipse 91 for the first receiver device RX1;
2) located on return ellipse 92 for the second receiver RX2; and
3) located in the beam forming direction and beam spread 90 of the transmitted radar signal.

In an alternative embodiment, the transmitter device can serve as one of the multiple receiver devices, in which case, due to the colocation of the transmitter device and the receiver device, it generates a range circle of equal distance instead of a range ellipse.

A use of a transmitter device and a receiver device that both operate to receive and process the radar signals enables an improved position location estimation if the location of the receiver device and the transmitter device are known (e.g., in the case of a distributed access device unit (e.g., gNB-DU)).

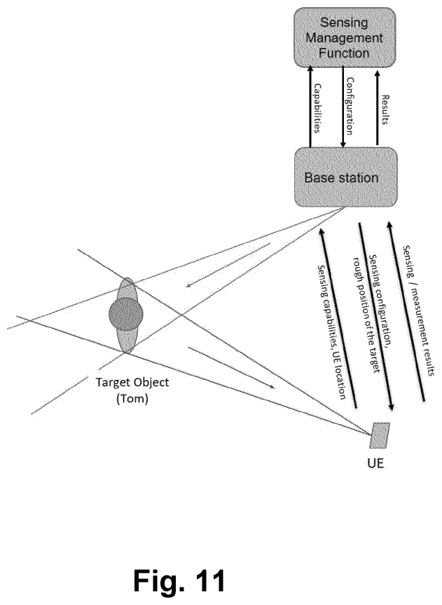

FIG. 10 schematically shows an example of an improved position location estimation with one receiver device RX1 and one transmitter device TX that also operates as a receiver device, according to an embodiment.

In the example of FIG. 10, an equal-distance return ellipse (range ellipse) 91 is obtained for the receiver device RX1 and an equal-distance return circle (range circle) 93 is obtained for the combined transmitter/receiver device TX. Again, only one of the intersection points (star-shaped markers) is selected as target location 95, since it meets the following three criteria that define a unique target location:
1) located on return circle 93 for TX;
2) located on return ellipse 95 for RX1; and
3) located in beam forming direction and beam spread 90 of the transmitted radar signal.

In an alternative embodiment related to FIG. 10, the target object is also a UE with RX capabilities. Thus, the target object at the target location 95 can estimate its distance D2 to the

TX by means of the received chirp signal. The receiver device RX1 can also obtain its direct (without reflection) distance D1 to the TX by means of the received chirp signal or by using round-trip time measurements or other distance calculation methods (such as TDOA). Furthermore, the receiver device RX1 can obtain the distance D to the TX over the target location 95 by means of the received reflected chirp signal. The distance from RX1 to the target object is therefore D3=D−D2. If the locations of TX and RX1 are known, then the location of the target object can be determined since D3 and D2 are known.

### Distributed Sensing Operated by Network Function

Another embodiment is represented in FIG. 11. shows an example of a distributed sensing system whereby the network (e.g. a RF Sensing Management Function (RSMF) deployed by a 5G Core Network) configures/controls the configuration parameters and/or sensing requirements, and/or collects/combines the sensing results of the sensing transmitter and/or the sensing receiver. Such RSMF could be deployed as a separate function/service in the core network, part of an existing function in the core network (e.g. as part/extension of a Location Management Function as specified in 3GPP TS 23.273), as part of a wireless access device (such as a base station), or e.g. as part of an application function or Edge application or cloud server (that may indirectly provide the configuration information or sensing requirements and/or receive the sensing results via a Network Exposure Function (NEF)), and may in general be seen as a sensing service and/or support the capabilities as described for a sensing service as described in other embodiments.

An RSMF may comprise a network communication unit capable of transmitting and receiving messages to/from a sensing transmitter and/or sensing receiver and/or other core network functions/services (e.g. as specified in 3GPP TS 23.501), and may comprise non-volatile storage to store the sensing capabilities received from a sensing transmitter or sensing receiver, and may comprise a processing unit to run a sensing application or operation, to determine the parameters to be configured to a sensing transmitter and/or sensing receiver (e.g. based on the received capabilities from a sensing receiver and/or sensing transmitter, the sensing requirements (e.g. as received from or determined by an application or other service), and/or information about target objects), to collect sensing results from a sensing transmitter and/or sensing receiver, and/or to further process the received/collected sensing results.

An RSMF may be deployed as part of a system comprising a set of sensing transmitter devices (e.g. base stations, access points or UEs (e.g. mobile phones)) and a set of sensing receiver devices (e.g. base stations, access points or UEs (e.g. mobile phones)), whereby the RSMF may be (securely) connected directly or indirectly via a set of wireless and/or wireline connections to these sensing transmitter devices and sensing receiver devices, and whereby the RSMF and the involved sensing transmitter and sensing receiver devices may communicate with each other through a messaging protocol (e.g. a protocol based on or extending the Non-Access Stratum (NAS) protocol as defined in 3GPP TS 24.501, Radio Resource Control (RRC) protocol as defined in 3GPP TS 38.331, or LTE Position Protocol (LPP) or NR Positioning Protocol (NRPP) as defined in 3GPP TS 37.355 respectively TS 38.455).

An RSMF, a sensing transmitter device and/or a sensing receiver device may support a method/service flow comprising the following steps which may be performed in any order:
When a UE registers to the network, the UE may provide its wireless sensing capabilities, for example device information (such as number of antennas or supported frequency ranges), wireless sensing signal processing capabilities, ability to be a sensing receiver or sensing transmitter or both, wireless sensing signal transmission capabilities (e.g. frequencies, timing, phase, type of signals it can generate), etc. to the RSMF. This may be done via a base station that is capable to act as a sensing transmitter or via another base station. It may also include its own position information, if known. Alternatively or additionally, the position of the UE may be obtained from a Location Management Function (LMF) or Location server or from a wireless access device (e.g. base station) to which the UE is connected. Similarly, when a wireless access device such as a base station (e.g. mobile base station relay device) is added to the network it may provide its wireless sensing capabilities to the RSMF. The wireless access device or core network function (e.g. AMF) to which the UE gets registered may forward/redirect the signals or messages or capability information received from the UE to the RSMF (e.g. based on the UE's identity, session identity or RSMF identity that may be provided in the registration message). The UE may also send its capabilities after initial registration, e.g. using RRC UECapabilityInformation message (as specified in 3GPP TS 38.331), or through an LPP ProvideCapabilities message (as specified in 3GPP TS 37.355), or as part of a sensing session setup request message (e.g. a separate/new Non-Access Stratum (NAS) message by extending the messages as defined in 3GPP TS 24.501, a separate/new Radio Resource Control (RRC) message by extending the messages as defined in 3GPP TS 38.331, or a separate/new LTE Position Protocol (LPP) or NR Positioning Protocol (NRPP) message by extending the messages as defined in 3GPP TS 37.355 respectively TS 38.455). Note that the capabilities of each of the devices involved in sensing may be different. For example, the RF signal processing capabilities of a UE may be different than from a base station, e.g, a UE may be capable of determining a position or movement of a target object, but may not be capable to determine a shape of a target object, or e.g a UE may be capable of receiving and perform measurements on the received sensing signals, but not be able to generate and transmit wireless sensing signals. Hence the configuration of each of these sensing transmitter devices and sensing receiver devices may be different or may change depending on the capabilities or the role (e.g. act as sensing transmitter or sensing receiver) they take. If a device can act as both a sensing transmitter and sensing receiver, the transmitting and receiver roles may be configured and/or activated independently, and may change dynamically (e.g. may act intermittently as a sensing transmitter and sensing receiver or act as both sensing transmitter and sensing receiver simultaneously depending on a given schedule or based on messages received e.g. by the RSMF or other network function, or local application).
Based on the sensing needs of a core network service (e.g. provided by or via GMLC or LMF or AMF) or external application (e.g. provided via NEF) or a UE (e.g. provided during registration with the core network) and/or based on the received capabilities, the RSMF may determine a set of wireless access devices (e.g. base stations) and/or UEs and/or other devices to be used for sensing, and configure one (or more) of these devices as a transmitter of the wireless sensing signals. To this end, a core network service may provide the relevant information (e.g. sensing needs/requirements) for sensing by issuing a request for sensing by using an Network Initiated Location Request (NI-LR) (e.g. as defined in TS 23.273) to the RSMF, which may be extended to include information about a target to be sensed and/or sensing requirements (e.g. which sensing results, e.g. velocity, need to be calculated, and/or accuracy requirements) and/or sensing configuration information (e.g. target location/area/volume information) and/or capability information of one or more sensing receivers or sensing transmitters, and which the RSMF is able to receive and interpret, upon which the RSMF may initiate the selection and configuration of the sensing transmitter devices. Similarly the UE may issue a Mobile Originated Location Request (MO-LR) or another client (e.g. application function) may issue a Mobile Terminated Location Request (MT-LR) to the RMSF, carrying the above mentioned information. Additionally, one or more of the set of wireless access devices (e.g. base stations) and/or UEs and/or other devices to be used for sensing are configured by the RSMF as a receiver of the wireless sensing signals. Sensing transmitter and sensing receiver may also be co-located. The device configuration information may include information about the wireless sensing signal to be used (e.g. timing, frequency, phase offset, identification of a wireless sensing signals), an identification of an algorithm or filter to be used for processing, wireless sensing application or session identifier, destination for sending the signal processing results to, etc. (e.g. as described in other embodiments). Some of these parameters may also be determined by the devices themselves, e.g., a sensing transmitter may decide the timing of the sensing signal (i.e., which resources are used for the sensing signal). Such parameters may be directly exchanged with the receiver(s) (e.g. through a Downlink Control Information (DCI) or Sidelink Control Information (SCI) signal/message as specified in 3GPP TS 38.212 (e.g. with a particular (new) format identifiable to denote reception or transmission of sensing signals and/or sensing signal parameters such as frequency) or a Semi-Persistent Schedule (SPS) denoting a repeating set of resources used for sensing signals) or indirectly through the core network.
Based on the sensing needs of a core network service or external application, the RSMF may obtain information about a set of target objects, which may include (rough) location information (or e.g. last known location) or area information (e.g. address of factory, hospital or house, or a denoted (geographical) area/volume) in which the target object is expected to reside or where it often resides, or may include information on how to identify a certain target object (e.g. physical characteristics, material, shape, etc.), or may include identities of devices that the person may own or carry etcetera (e.g. as described in other embodiments). The RSMF may use this information about the set of target objects to select and configure a set of sensing transmitter and/or sensing receiver devices to participate in the sensing of the indicated target/target area/volume, (this may include information about the wireless sensing signal to be used as described in the previous bullet), and/or may forward/configure some of this information to a set of sensing transmitter and/or sensing receiver devices. The RSMF or the sensing transmitter or the receiver device itself may also provide position/location information about itself or other sensing transmitter devices or sensing receiver devices to other sensing transmitter and sensing receiver devices.

Alternatively, if this information is not available, the RSMF may trigger a (broadcast) search function in which the sensing transmitters are requested to sense the environment to determine the rough location information of the set of target objects.

Alternatively or additionally, one (or more) of the devices involved in the sensing (e.g. a base station that may include both sensing transmitter and sensing receiver capabilities) may determine a rough position/location of the target object(s) (e.g. based on non-distributed radar based sensing) and provide this information to the RSMF. Alternatively or additionally, a rough location (or last known location) of the target object or more generally a target location/area/volume may be provided by an external application (e.g. through NEF) or may e.g. be obtained from the LMF [as specified in 3GPP TS 23.273] or the Network Data Analytics Function (NWDAF) [as specified in 3GPP TS 23.288] (e.g. based on the identity of a device/UE expected/known to be attached/carried by the target object). The RSMF or a sensing transmitter/receiver may provide the rough position/location information about the target object(s) or more generally a target location/area/volume to the involved sensing receiver device(s) and sensing transmitter device(s).

Alternatively or additionally, the sensing function/service (RSMF) may obtain information about devices (e.g. their identities and estimated location) that are in the vicinity of a target object (e.g. a set of nearby base stations or UEs in vicinity that are capable and that may be authorized (or are authorized) by the network and/or by the user of the device and/or by the target person or target object owner to participate in (distributed) sensing of the intended target. The authorization information (which may also include user consent information) may be stored as part of a user's subscription (e.g. in the Unified Data Management (UDM) function of the core network) and/or as part of the RSMF and/or may be received from a service or application function or external application (e.g. through the NEF). The RSMF may use the information about sensing transmitter and sensing receiver devices in vicinity of a target object in its selection and configuration of sensing transmitter and sensing receiver devices to be used. The devices involved in sensing may be invited/configured to be involved in a sensing session by sending a message that may include a session identifier and/or sensing signal identifier.

Alternatively or additionally, an initial radar scan or sensing operation performed by one of the sensing devices that may support both transmitter and receiver roles may show that the obtained accuracy of the sensing measurements may not be sufficient to meet the desired accuracy (e.g. as indicated/received/configured in the RSMF e.g. by an external application). The sensing devices involved may determine this themselves and inform the RSMF about it, or the RSMF may determine this based on the sensing results it may receive from the respective sensing devices. Alternatively or additionally, the RSMF may determine based on the capabilities of the sensing transmitter and receiver devices and/or the available bands/spectrum in a certain area, and/or through previous measurements (e.g. obtained by/from a network analytics function such as NWDAF) that the accuracy by the involved sensing transmitter/receiver device(s) and/or the accuracy that can be obtained in a given sensing area may not be sufficient for the application's requirements. The RSMF may use this information (possibly together with the received capabilities and location information of sensing transmitter and sensing receiver devices in an area) as a trigger to select other/additional sensing transmitter and/or sensing receiver devices in the vicinity of the target object and/or to improve the sensing measurements and sensing accuracy (e.g. by changing to a higher frequency, larger bandwidths, by increasing the number of signals and/or signal measurements, or by selecting different algorithms).
The RSMF may activate one or more of the selected sensing transmitter devices or sensing receiver devices to activate the sensing, e.g. by initiating a sensing session. The activation of the sensing transmitter and/or sensing receiver may be triggered automatically by receiving the above mentioned sensing configuration (e.g. given a start time or a set of time intervals when the sensing signals will be transmitted), or may get triggered through a separate message (e.g. an additional LPP message containing for example a sensing session identifier) or separate signal (e.g. an identifiable sensing signal being detected matching one or more of the given signal characteristics or signal identifiers provided during configuration).
Based on the received configuration information and/or rough location of the target object or more generally a target location/area/volume, one or more of the sensing transmitter devices will direct a wireless sensing signal to the target object(s) (e.g. by directing the wireless sensing signal to the target location/area/volume). The time at which such signal is transmitted is based on e.g. timing information (e.g. a sensing start time or a set of time intervals for sensing or a (pre-configured) set of time/frequency resources) as configured and e.g. shared with the sensing receiver devices and other sensing transmitter devices. The sensing receiving device(s) will receive the reflected wireless sensing signal and be able to recognize and process the received reflected sensing signals based on the wireless sensing configuration information that was provided (e.g. as described in other embodiments). In an example, based on the received reflected signals, the timing information of when a signal was sent (e.g. as configured or part of timestamp information in the signal), its own known location and the location of the sensing transmitter (e.g. base station), a position/location of the target object can be estimated, e.g. by using triangulation. Additionally or alternatively, each sensing receiving or sensing transmitter device will send its wireless sensing signal measurements and/or processing results to the configured destination (e.g. RSMF) which collects the results and can perform further processing on these results. The RSMF may use all received/collected measurements and/or (partial) sensing results to determine a set of sensing result. This may be based on the sensing requirements received in the location/sensing request (e.g. as received from the application). The sensing results (e.g. position of the target) may be provided to the entity (e.g. GMLC/AMF/NEF/UE) that issued or forwarded the “extended” location request to the RSMF. Alternatively or additionally, the sensing results may be stored in a shared storage, e.g. Unified Data Repository (UDR).

In other words, an RSMF will typically be able to retrieve the wireless sensing capabilities of sensing receiver devices and/or sensing transmitter devices, be able to configure one or more sensing transmitter devices and/or sensing receiver devices to take part in distributed wireless sensing of a target object, and be able to configure a wireless sensing capable UE with information of which network entity or destination server to send the wireless sensing results to, and may be able to configure a wireless sensing capable sensing transmitter and/or sensing receiver with information on when and how to transmit and/or receive and/or process a wireless sensing signal, and may be able to collect and further process wireless sensing measurements/results from the sensing transmitter devics and/or sensing receiver devices.

To summarize, systems and methods for providing sensing capability, e.g., radar-based sensing capability, in a wireless communication system have been described, wherein a part of the communication spectrum is configured for a period of time to enable performing sensing by establishing a distributed sensing system between a wireless access device (e.g. base station) or terminal device as transmitter device, and a terminal device or a wireless access device (e.g. base station) as receiver device in such a way that the lack of analogue signal exchange and the additional path length caused by the transmitter-receiver distance (and, in embodiments, the receiver-target distance) are corrected for, while parameters that need to be communicated are configured for the application required.

While the invention has been illustrated and described in detail in the drawings and foregoing description, such illustration and description are to be considered illustrative or exemplary and not restrictive. The invention is not limited to the disclosed embodiments. It can be applied to various types of UEs or terminal devices, such as mobile phone, vital signs monitoring/telemetry devices, smartwatches, detectors, vehicles (for vehicle-to-vehicle (V2V) communication or more general vehicle-to-everything (V2X) communication), V2X devices, Internet of Things (IoT) hubs, IoT devices, including low-power medical sensors for health monitoring, medical (emergency) diagnosis and treatment devices, for hospital use or first-responder use, virtual reality (VR) head-sets, etc.

Moreover, the above embodiments may be implemented in a quasi-distributed deployment where the base station is a central unit (e.g., gNB-CU) and there are two distributed units (e.g., gNB-DUs), one acting as the transmitter device and the other acting as the receiver device, while the central unit may be the entity synchronizing the distributed units.

The base station may be any network access device (such as a base station, Node B (eNB, eNodeB, gNB, gNodeB, ng-eNB, etc.), Integrated Access and Backhaul (IAB) relay node, access point or the like) that provides a geographical service area.

Furthermore, at least some of the above embodiments may be implemented to provide network equipment for 5G/6G/xG cellular networks or a new product class of (low-cost/mid-cost) reconfigurable intelligent surfaces to improve coverage, reliability and speed of cellular networks.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. Throughout the description and the claims, the expressions “at least one of A, B and C” or “at least one of A, B or C” should generally be understood as meaning “A and/or B and/or C”. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

The described operations like those indicated in FIGS. 4 to 7 can be implemented as program code means of a computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus comprising:
a communication circuit, wherein the communication circuit is arranged to receive a communication signal from a remote communication device;
a detection circuit,
wherein the detection circuit is arranged to detect a sensing signal based on sensing parameter information,
wherein the sensing parameter information comprises the communication signal;
an analysis system
wherein the analysis system is arranged to determine a change of the sensing signal,
wherein the change is selected from the group consisting of a timing, phase shift, frequency, amplitude or deformation,
wherein the analysis system is arranged to determine if the sensing signal is reflected by a target object or is sent via a direct non-reflected path based on the change of the sensing signal.

2. The apparatus of claim 1, where the sensing signal is selected from the group consisting of a radar signal, a chirp signal, or a training symbol of a channel state information.

3. The apparatus of claim 1, wherein the apparatus is arranged to use the communication circuit, to transmit a sensing measurement request to the remote communication device so as to receive at least one of sensing parameter information, resource allocation information for sensing or a location of the remote communication device.

4. The apparatus of claim 1, wherein the apparatus is arranged to use the communication circuit to transmit at least one of a required scan time for sensing measurement and a indication of a direction and range to the target object or an indication of a location or area of the target object or an indication of a location or area of the communication device or an indication of a direction and range between the communication device and the remote communication device to the remote communication device.

5. The apparatus of claim 1, wherein the sensing parameter information is selected from the group consisting of timing, phase and frequency information, an identification of an algorithm, an identification of a filter, an application identifier, a sensing signal identifier of the sensing signal or a sensing profile identifier.

6. The apparatus of claim 1, further comprising a signal generator circuit, wherein the signal generator circuit is arranged to generate a synthetic sensing signal based on the sensing parameter information or an auxiliary signal, wherein the analysis system is arranged to combine the synthetic sensing signal with the sensing signal.

7. The apparatus of claim 6,
wherein the signal generator circuit is arranged to use a discrete Fourier transform spread orthogonal frequency division multiplexing signal generation process to generate a chirp signal as the synthetic sensing signal,
wherein the synthetic sensing signal matches sensing parameter information.

8. The apparatus of claim 6,
wherein the analysis system is arranged to generate an intermediate frequency signal by combining the synthetic sensing signal with the sensing signal,
wherein the analysis system is arranged to convert the intermediate frequency signal so as to obtain a digital intermediate frequency signal,
wherein the analysis system is arranged to process the digital intermediate frequency signal to yield position, movement or structure data.

9. The apparatus of claim 8,
wherein the analysis system is arranged to detect a location and/or movement of the target object based on an isolated surface derived from a constant line detected in the digital intermediate frequency signal,
wherein the analysis system is arranged to detect a heart rate and breathing rate based on isolated and unwrapped phase data of a selected surface derived from a constant line detected in the digital intermediate frequency signal, or to measure a skin conductivity based on an estimation of a total reflectivity of a selected surface derived from a constant line detected in the digital intermediate frequency signal.

10. The apparatus of claim 1, wherein the apparatus is arranged to provide a time delay measurement by using the communication circuit, to perform a two-way time delay measurement in cooperation with the remote communication device.

11. The apparatus of claim 1, further comprising at least one movement sensor, wherein the at least one movement sensor is arranged to measure movements and/or vibrations of the communication device.

12. The apparatus of claim 11, wherein the measured movements and/or vibrations of the communication device are communicated to the remote communication device.

13. The apparatus of claim 1, further comprising a lower-resolution non-distributed analysis system, wherein the non distributed analysis system is arranged to provide a non-distributed location scanning capability.

14. The apparatus of claim 1, wherein the analysis system is arranged to detect a spatial location of a surface of the target object by finding intersections of equal-distance return ellipses of receiver devices of the sensing signal and constraining the position by a direction angle and beam spread angle of a transmitter beam of the remote communication device.

15. The apparatus of claim 1,
wherein the analysis system is arranged to a first detection,
wherein the first detection detects that the sensing information about a target object or the determined position, a movement or a structure of a target object does not correspond to the given information on how to identify the target,
wherein the apparatus discards the sensing signal or sensing information, and/or not perform any further processing on the measurements, results and/or input/output data, and/or not transmit to a further processing circuit based on the first detection.

16. The apparatus of claim 1,
wherein the analysis system is arranged to detect a biometric based on the sensing information about a target object and/or the determined position, a movement or a structure of a target object,
wherein the sensing session may be continued or aborted or the sensing information may be approved for further processing/storage or discarded, or a different target object or different communication device or different remote communication device may be selected based on the biometric.

17. (canceled)

18. (canceled)

19. The apparatus of claim 1,
wherein the remote communication device is arranged to determine if it can respond to a sensing measurement request
wherein the remote communication device responds respond a sensing session confirmation or a sensing session denial message based on the change of the sensing signal.

20. The apparatus of claim 1,
wherein the remote communication device is arranged to determine the sensing parameter information,
wherein the sensing parameter information comprises of a signal to be used as the sensing signal, a rough position of the target object and a position offset from the remote communication device to the communication device,
wherein the remote communication device is arranged to transmit the sensing parameter information and a future time for a first sensing signal to the communication device.

21. The apparatus of claim 20,
wherein the remote communication device is arranged to transmit the sensing signal at the communicated future time using a discrete Fourier transform spread orthogonal frequency division multiplexing signal generation process
wherein the remote communication devices is arranged to generate the sensing signal by converting a single-carrier discrete Fourier transform spread orthogonal frequency division multiplexing signal to a linear combination of sensing signals circularly translated in the time domain.

22. The apparatus of claim 1, wherein the remote communication device is arranged to determine a target angle and a distance to the target object by using a location estimation sensing operation of a non-distributed sensing system.

23. The apparatus of claim 1,
wherein the remote communication device is arranged to use a communication circuit.

24. The apparatus of claim 1, wherein a clock-level synchronization between the remote communication device and the communication device is achieved by a time synchronization and delay compensation measurement process using communication signals.

25. The apparatus of claim 1,
wherein the communication device is arranged to transmit to the remote communication device a resource scheduling message requesting scheduling of sensing session resources,
wherein the remote communication device replies to the communication device with a downlink control information message including the allocated resources.

26. A method comprising:
receiving a communication signal from a remote device;
detecting a sensing signal based on sensing parameter information, wherein the sensing parameter information comprises the received communication signal;
determining determine a change of the sensing signal, wherein the change is selected from the group consisting of a timing, phase shift, frequency, amplitude or deformation; and
determining if the sensing signal is reflected by a target object or is sent via a direct non-reflected path based on the change of the sensing signal.

27. A computer program stored on a non-transitory medium, wherein the computer program when executed on a processor performs the method as claimed in claim 19.

28. An apparatus comprising:
a communication circuit, wherein the communication circuit comprises a transmitter and a receiver; and
a controller circuit,
wherein the controller circuit is arranged to control the communication circuit,
wherein the controller circuit, is arranged for performing a sensing session upon reception of a request for sensing a target.

29. The apparatus of claim 28,
wherein the request comprises configuration parameters,
wherein the configuration parameters are chosen from the group consisting of authorization information, target information, context information, an identifier or a credential or a target position, movement or vital signs,
wherein the target information comprises target location, target area, target volume or target situation,
wherein the target situation comprise mobility, position or vital signs,
wherein the context information comprises presence of other persons around the victim, distance between people, number of injured people or debris in vicinity,
wherein the identifier comprises an IP address or a URL of a destination server, or network function/device or public safety answering point,
wherein the a credential is be used for encryption.

30. (canceled)

31. The apparatus of claim 28,
wherein the controller circuit, is arranged to initiate an emergency call,
wherein the emergency call causses the sensing session.

32. The apparatus of claim 31, wherein the emergency call comprises location information.

33. The apparatus of claim 31, wherein emergency call comprises sensing results.

34. The apparatus of claim 31, wherein the controller circuit, is arranged to provide include the apparatus sensing capabilities and/or an indication that sensing results are available or can be acquired.

35. A network node in a communication network, comprising
a communication circuit, wherein the communication circuit comprises a transmitter and a receiver; and
a controller circuit,
wherein the controller circuit is arranged to control the communication circuit,
wherein the controller circuit, is arranged to request at least one sensing devices located in the vicinity of a first device to perform a sensing session of a designated target upon reception of an emergency call from the first wireless device.

36. A method comprising:
receiving a sensing request for a designated target victim in the vicinity of an apparatus; and
performing a sensing session based on the request.

37. A method comprising:
receiving an emergency call from a first device; and
requesting at least one sensing devices located in the vicinity of the first device to perform a sensing session of a designated target victim.

38. A computer program stored on a non-transitory medium, wherein the computer program when executed on a processor performs the method as claimed in claim 37.

39. An apparatus comprising:
a communication circuit, wherein the communication circuit is arranged to receive a communication signal from a remote communication device;
a detection circuit,
wherein the detection circuit is arranged to detect a sensing signal at the output of the reception frontend based on sensing parameter information,
wherein the sensing parameter information comprises the communication signal;
an analysis system
wherein the analysis system is arranged to generate a filtered signal bases on the sensing signal,
wherein the analysis system is arranged to provide the filtered signal to a second processing circuit,
wherein the second processing circuit is arranged to extract sensing information about a target object.

40. An apparatus comprising:
a communication circuit, wherein the communication circuit is arranged to receive a communication signal from a remote communication device;
a detection circuit,
wherein the detection circuit is arranged to detect a sensing signal at the output of the reception frontend based on sensing parameter information,
wherein the sensing parameter information comprises the communication signal;
an analysis system
wherein the analysis system is arranged to determine a position, a movement or a structure of a target object based on the sensing signal.

41. The apparatus of claim 6,
wherein the analysis system is arranged to generate an intermediate frequency signal by combining the synthetic sensing signal with the sensing signal,
wherein the analysis system is arranged to convert the intermediate frequency signal so as to obtain a digital intermediate frequency signal,
wherein the analysis system is arranged to transmit the digital intermediate frequency signal to the remote communication device.

42. The apparatus of claim 1,
wherein the remote communication device is arranged to use a non-distributed radar operation to perform sensing of the communication device,
wherein the remote communication device is arranged to calculate a time delay based on the sensing results of the non-distributed radar operation,
wherein the remote communication device is arranged to transmit the calculated time delay to the wireless communication device.

43. A method comprising:
receiving a communication signal from a remote device;
detecting a sensing signal based on sensing parameter information, wherein the sensing parameter information comprises the received communication signal;
determining determine a change of the sensing signal, wherein the change is selected from the group consisting of a timing, phase shift, frequency, amplitude or deformation; and
providing a filtered signal a second processing circuit,
wherein the second processing circuit is arranged to extract sensing information about a target object.

44. A method comprising:
receiving a communication signal from a remote device;
detecting a sensing signal based on sensing parameter information, wherein the sensing parameter information comprises the received communication signal;
determining determine a change of the sensing signal, wherein the change is selected from the group consisting of a timing, phase shift, frequency, amplitude or deformation; and
determining a position, a movement or a structure of a target object.
